(19) United States
(12) Patent Application Publication
(10) Pub. No.: US 2017/0193492 A1
(43) Pub. Date: Jul. 6, 2017

(54) USER EQUIPMENT, SERVICE PROVIDING DEVICE, PAYMENT SYSTEM COMPRISING THE SAME, CONTROL METHOD THEREOF, AND NON-TRANSITORY COMPUTER-READABLE STORAGE MEDIUM STORING COMPUTER PROGRAM RECORDED THEREON

(71) Applicant: SK Planet Co., Ltd., Seongnam-si (KR)

(72) Inventor: HyunWook KIM, Seongnam-si (KR)

(21) Appl. No.: 15/286,134

(22) Filed: Oct. 5, 2016

(30) Foreign Application Priority Data
Dec. 30, 2015 (KR) 10-2015-0189181
Dec. 30, 2015 (KR) 10-2015-0189182

(51) Int. Cl. G06Q 20/32; G06Q 10/08; G06Q 30/06; G06K 7/10

(52) U.S. Cl. CPC G06Q 20/3278; G06K 7/10297; G06Q 10/087; G06Q 30/0601

(57) ABSTRACT

Provided are user equipment, a service providing device, a POS terminal, a payment system including the same, a control method thereof, and a non-transitory computer-readable storage medium storing a computer program recorded thereon. That is, according to the exemplary embodiment of the present invention, a combination of tags for products to be purchased and a tag for a shopping mall is input at one time to allow the lump sum purchase and a delivery status of the product which is currently being delivered may be checked through tagging. Therefore, the purchasing convenience of the user is improved and the convenience of the user is also improved.

### CROSS-REFERENCE TO RELATED APPLICATION

This application claims the benefit of Korean Application Nos. 10-2015-0189181 and 10-2015-0189182 filed on Dec. 30, 2015 with the Korean Intellectual Property Office, the disclosure of which is incorporated herein by reference.

### BACKGROUND OF THE INVENTION

1. Field of the Invention

The present invention relates to user equipment, a service providing device, a payment system including the same, a control method thereof, and a non-transitory computer-readable storage medium storing a computer program recorded thereon. More particularly, the present invention relates to user equipment, a service providing device, a payment system including the same, a control method thereof, and a non-transitory computer-readable storage medium storing a computer program recorded thereon which receive a combination of tags for products to be purchased and a tag for a shopping mall at one time to allow lump sum purchase and check a delivery status of a product which is currently being delivered through the tagging.

2. Description of the Related Art

As a simple online-ordering method, a dash button service of Amazon is currently being used.

The Amazon dash button service is configured to allow a user to independently access a Wi-Fi access point to create order related information of a specific product to provide the order related information to an Amazon server and allow the user to check the ordering statement thorough a user terminal.

However, the Amazon dash button requires a complex hardware configuration and a power supply and allows only an order fixed to specific products.

In addition to the above-described method, a service which sets a tag to purchase a specific product from a specific shopping mall using a usage method of an NFC tag which is generally used and brings a smart phone into contact with the tag to easily access a specific shopping mall or automatically search a specific product may be configured. However, according to the above-described method, when a unique identifier of the tag is discerned, a user may access the specific shopping mall or access the shopping mall through access information or search information set in a user terminal to search a product. Therefore, a user setting is little bit complex and only accessibility is provided. Therefore, the above-described method may be replaced just by operating a shopping mall app of the user terminal without accessing the tag, so that practicality thereof is low.

### RELATED ART DOCUMENT

### Patent Document

Korean Unexamined Patent Application Publication No. 10-2013-0131139 (entitled product purchase system using NFC tag)

### SUMMARY OF THE INVENTION

An object of the present invention is to provide user equipment, a service providing device, a payment system including the same, a control method thereof, and a non-transitory computer-readable storage medium storing a computer program recorded thereon which receive a combination of tags for products to be purchased and a tag for a shopping mall at one time to allow lump sum purchase and check a delivery status of a product which is currently being delivered through the tagging.

Another object of the present invention is to provide user equipment, a service providing device, a payment system including the same, a control method thereof, and a non-transitory computer-readable storage medium storing a computer program recorded thereon which use a specific online shopping mall or a tag which induces a connected status for purchasing a specific product in the shopping mall, but continuously tag an NFC tag related with a plurality of products in user equipment and then place a lump sum order of the plurality of tagged products, which is different from an NFC tagging method which performs one independent job by one contact.

Still another object of the present invention is to provide user equipment, a service providing device, a payment system including the same, a control method thereof, and a non-transitory computer-readable storage medium storing a computer program recorded thereon which provide a delivery tracking screen for an order including a product which is ordered through the NFC tag but is not delivered, just by tagging an NFC tag.

Another object of the present invention is to provide user equipment, a service providing device, a payment system including the same, a control method thereof, and a non-transitory computer-readable storage medium storing a computer program recorded thereon which receive a combination of tags for products to be purchased and a tag for a shopping mall at one time to allow a lump sum purchase and apply different delivery addresses, payment means, and recommendation profiles in accordance with the position of the user equipment even though the same tag is used.

Another object of the present invention is to provide user equipment, a service providing device, a payment system including the same, a control method thereof, and a non-transitory computer-readable storage medium storing a computer program recorded thereon which use a tag which induces a connection status for purchasing a specific product in a specific on-line shopping mall or a shopping mall but continuously tag an NFC tag related with a plurality of products in user equipment and then place a lump sum order of the plurality of tagged products, which is different from an NFC tagging method which performs one independent job by one contact.

Another object of the present invention is to provide user equipment, a service providing device, a payment system including the same, a control method thereof, and a non-transitory computer-readable storage medium storing a computer program recorded thereon which automatically apply additional setting information for shopping in accordance with a tagging position and a tagging time of the user equipment.

According to an aspect of the present invention, user equipment includes a user equipment reader unit which tags a first NFC tag; a user equipment storing unit which stores a product corresponding to identification information of an NFC tag which is previously purchased in the user equipment and is being delivered; a user equipment control unit which checks whether a first product corresponding to identification information of the tagged first NFC tag is included in the product corresponding to the identification information of the NFC tag which is stored in the user equipment storing unit and is being delivered and checks position information of a delivery vehicle which is delivering the first product when the first product is included in the product corresponding to the identification information of the NFC tag which is being delivered as a checking result; and a user equipment display unit which displays the checked position information of the delivery vehicle which is delivering the first product.

In an embodiment of the present invention, when the first product is not included in the product corresponding to the identification information of the NFC tag which is being delivered as a checking result, the user equipment control unit may displays product information of the first product related with the first NFC tag which is repeatedly purchased on the user equipment display unit and automatically add the product information in a cart item.

In an embodiment of the present invention, when there is no product which is being delivered related with the user equipment, the user equipment control unit may display product information related with the first NFC tag on the user equipment display unit and automatically add the product information in a cart item.

In an embodiment of the present invention, the product information related with the first NFC tag which is displayed on the user equipment display unit may be product information of the cheapest product among search results in a shopping mall site set for the first product related with the first NFC tag which is repeatedly purchased.

In an embodiment of the present invention, search result from the shopping mall site set for the first product related with the NFC tag may be displayed on the user equipment display unit and the product information related with the first NFC tag which is displayed on the user equipment display unit may be product information of a product selected from the search result displayed on the user equipment display unit.

In an embodiment of the present invention, the user equipment control unit may check whether the tagging of the NFC tag is completed and perform a payment function in accordance with a lump sum ordering function on a product related with the product information stored in the cart item when a tagging function is not performed on another NFC tag as a checking result.

In an embodiment of the present invention, when the payment function on the product is normally completed, the user equipment control unit may provide additional setting information including a delivery address based on position information of the user equipment to a service providing device.

In an embodiment of the present invention, the user equipment control unit may perform a payment function in accordance with a lump sum ordering function on the product related with the product information stored in the cart item based on card information stored for simple payment.

According to another aspect of the present invention, a user equipment includes a user equipment storing unit which sets unique identification information of a first NFC tag which is tagged in the user equipment to interlock with product information of a product purchased by the user equipment; a user equipment reader unit which tags a second NFC tag; a user equipment Global Positioning System (GPS) receiver which checks position information of the user equipment when the second NFC tag is tagged; a user equipment display unit which displays the product information; and a user equipment control unit which determines whether identification information of the tagged second NFC tag is included among unique identification information of the first NFC tag which interlocks with the product information of the purchased product stored in the user equipment storing unit, controls the user equipment display unit to display the product information of the purchased product interlocking with the identification information of the tagged second NFC tag when the identification information of the tagged second NFC tag is included among the unique identification information of the first NFC tag interlocking with the product information of the purchased product stored in the user equipment storing unit as a determination result, and adds the product information of the purchased product in the cart item.

In an embodiment of the present invention, when the identification information of the tagged second NFC tag is not included among the unique identification information of the first NFC tag interlocking with the product information of the purchased product stored in the user equipment storing unit as a determination result, the user equipment control unit may control the user equipment display unit to display the product information related with the tagged second NFC tag.

In an embodiment of the present invention, when a purchase confirmation button is selected, the user equipment control unit may perform a payment function in accordance with a lump sum ordering function on the product related with the product information stored in the cart item based on card information stored for simple payment.

In an embodiment of the present invention, the user equipment control unit may check additional setting information based on the checked position information of the user equipment and perform the payment function through payment card information in the checked additional setting information.

In an embodiment of the present invention, when the payment function is normally completed, the user equipment control unit may check additional setting information including at least one of a delivery address, payment card information, and recommendation criteria based on the checked position information of the user equipment and provide the checked additional setting information to a service providing device.

According to another aspect of the present invention, a control method of user equipment includes tagging a first NFC tag by means of user equipment reader unit; checking whether a first product corresponding to identification information of the tagged first NFC tag is included in a product corresponding to identification information of an NFC tag which is stored in a user equipment storing unit and is being delivered, by means of a user equipment control unit; checking position information of a delivery vehicle which is delivering the first product by means of the user equipment control unit when the first product is included in the product corresponding to the identification information of the NFC tag which is being delivered as the checking result; and displaying the checked position information of the delivery vehicle which is delivering the first product by means of a user equipment display unit.

In an embodiment of the present invention, the method may further include: displaying product information related with the first NFC tag on the user equipment display unit and automatically adding the product information in a cart item by means of the user equipment control unit when the product is not included in the product corresponding to the identification information of the first NFC tag which is being delivered as a checking result; checking whether the tagging of the NFC tag is completed by means of the user equipment control unit; and performing a payment function in accordance with a lump sum ordering function on a product related with the product information stored in the cart item based on card information stored for simple payment by means of the user equipment control unit when the tagging function on another NFC tag is not performed as a checking result.

According to yet another aspect of the present invention, a computer program executing the methods according to the aforementioned embodiments may be stored in a non-transitory computer-readable storage medium storing a computer program recorded thereon.

According to the present invention, a combination of tags for products to be purchased and a tag for a shopping mall is input at one time to allow the lump sum purchase and a delivery status of the product which is currently being delivered may be checked through tagging, thereby improving a convenience of the user.

According to the present invention, a specific online shopping mall or a tag which induces a connected status for purchasing a specific product in the shopping mall is used, but differently from the NFC tagging method which performs one independent job by one contact, a plurality of product related NFC tags is continuously tagged and then the plurality of tagged products is ordered in lump sum, thereby improving the purchase convenience of the user and the convenience of the user.

Further, according to the present invention, in the case of a product which is ordered through the NFC tag but is not delivered, a delivery tracking screen for the order including the product may be provided just by tagging the NFC tag, thereby improving the convenience of checking the order.

According to the present invention, a combination of tags for products to be purchased and a tag for a shopping mall is received at one time to allow lump sum purchase and different delivery address, payment means, and recommendation profiles are applied in accordance with the position of the user equipment even though the same tag is used so that the configuration is simple and maintenance cost for the tag is not necessary. Therefore, it is easy to distribute the tag so that it is easy to apply the present invention to a marketing which induces the repeated purchase of the specific shopping mall or a specific product.

According to the present invention, a specific online shopping mall or a tag which induces a connected status for purchasing a specific product in the shopping mall is used, but differently from the NFC tagging method which performs one independent job by one contact, a plurality of product related NFC tags is continuously tagged and then the plurality of tagged products is ordered in lump sum in the user equipment, thereby improving the purchase convenience of the user and the convenience of the user.

Further, according to the present invention, additional setting information for shopping is automatically applied in accordance with the tagging position and the tagging time of the user equipment, so that manipulation for purchasing is simple.

### BRIEF DESCRIPTION OF THE DRAWINGS

FIG. 1 is a block diagram illustrating a configuration of a payment system according to an exemplary embodiment of the present invention.

FIG. 2 is a block diagram illustrating a configuration of user equipment according to an exemplary embodiment of the present invention.

FIG. 3 is a block diagram illustrating a configuration of a payment system according to another exemplary embodiment of the present invention.

FIG. 4 is a block diagram illustrating a configuration of user equipment according to another exemplary embodiment of the present invention.

FIG. 5 is a block diagram illustrating a configuration of user equipment according to another exemplary embodiment of the present invention.

FIG. 6 is a flow chart illustrating a control method of a payment system according to a first exemplary embodiment of the present invention.

FIG. 7 is a view illustrating a screen of user equipment according to a first exemplary embodiment of the present invention.

FIG. 8 is a flow chart illustrating a control method of a payment system according to a second exemplary embodiment of the present invention.

FIG. 9 is a flow chart illustrating a control method of a payment system according to a third exemplary embodiment of the present invention.

### DETAILED DESCRIPTION OF THE PREFERRED EMBODIMENT

It is noted that technical terms used in the present invention are used to just describe a specific embodiment and do not intend to limit the present invention. Further, if the technical terms used in the present invention are not particularly defined as other meanings in the present invention, the technical terms should be appreciated as meanings generally appreciated by those skilled in the art and should not be appreciated as excessively comprehensive meanings or excessively reduced meanings. Further, when the technical term used in the present invention is a wrong technical term that does not accurately express the spirit of the present invention, the technical term should be understood by being substituted by a technical term which can be correctly understood by those skilled in the art. In addition, a general term used in the present invention should be interpreted as defined in a dictionary or contextually, and should not be interpreted as an excessively reduced meaning.

In addition, singular expressions used in the present invention include plurals expressions unless they have definitely opposite meanings. In the present invention, it should not analyzed that a term such as “comprising” or “including” particularly includes various components or various steps disclosed in the specification and some component or some steps among them may not be included or additional components or steps may be further included.

In addition, terms including ordinal numbers, such as ‘first’ and ‘second’, used in the present invention can be used to describe various components, but the components should not be limited by the terms. The above terms are used only to discriminate one component from the other components. For example, a first component may be named a second component and similarly, the second component may also be named the first component, without departing from the scope of the present invention.

Hereinafter, preferable exemplary embodiment of the present invention will be described in more detail with reference to the accompanying drawings. Like reference numerals refer to like elements for easy overall understanding and a duplicated description of like elements will be omitted.

Further, in the following description, a detailed explanation of known related technologies may be omitted to avoid unnecessarily obscuring the subject matter of the present invention. Further, it is noted that the accompanying drawings are only for easily understanding the spirit of the present invention and it should not be interpreted that the spirit of the present invention is limited by the accompanying drawings.

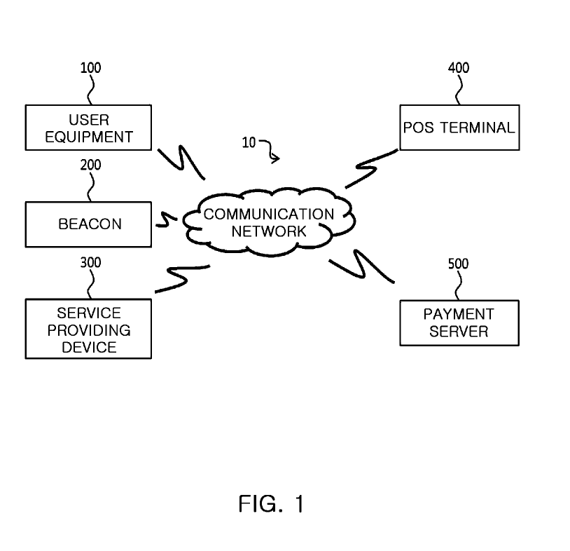

FIG. 1 is a block diagram illustrating a configuration of a payment system 10 according to an exemplary embodiment of the present invention.

As illustrated in FIG. 1, a payment system 10 is configured by user equipment 100, a beacon 200, a service providing device 300, a POS terminal 400, and a payment server 500. However, all the components of the payment system 10 illustrated in FIG. 1 are not essential components, but the payment system 10 may be implemented by more components or less components than the components illustrated in FIG. 1.

The user equipment 100 may be applied to various terminals such as a smart phone, a portable terminal, a mobile terminal, a personal digital assistant (PDA), a portable multimedia player (PMP) terminal, a telematics terminal, a navigation terminal, a personal computer, a notebook computer, a slate PC, a tablet PC, an ultrabook, a wearable device (for example, including a smart watch, a smart glass, or a head mounted display (HMD)), a Wibro terminal, an internet protocol television (IPTV) terminal, a smart TV, a digital broadcasting terminal, a television, a 3D television, a home theater system, an audio video navigation (AVN) terminal, an audio/video (A/V) system, or a flexible terminal.

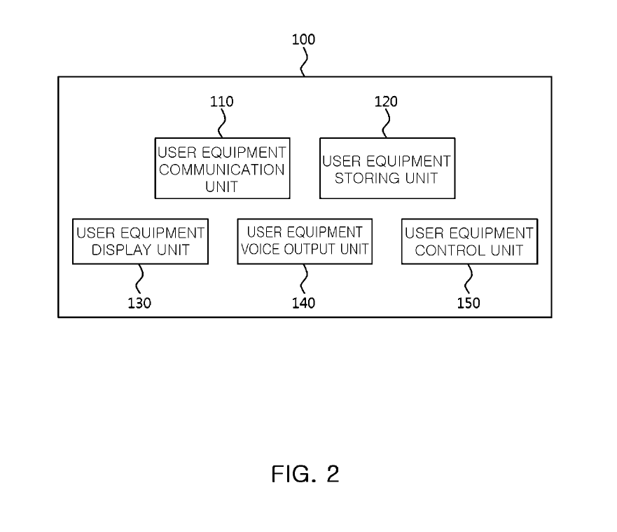

As illustrated in FIG. 2, the user equipment 100 is configured by a user equipment communication unit 110, a user equipment storing unit 120, a user equipment display unit 130, a user equipment voice output unit 140, and a user equipment control unit 150. However, all the components of the user equipment 100 illustrated in FIG. 2 are not essential components, but the user equipment 100 may be implemented by more components or less components than the components illustrated in FIG. 2.

The user equipment communication unit 110 connects an arbitrary internal component with at least one arbitrary external terminal through a wired/wireless communication network to communicate each other. In this case, the arbitrary external terminal may include the beacon 200, the service providing device 300, the POS terminal 400, and the payment server 500. Here, a wireless internet technique includes wireless LAN (WLAN), digital living network alliance (DLNA), wireless broadband (Wibro), world interoperability for microwave access (Wimax), high speed downlink packet access (HSDPA), high speed uplink packet access (HSUPA), IEEE 802.16, long term evolution (LTE), long term evolution-advanced (LTE-A), wireless mobile broadband service (WMBS). The user equipment communication unit 110 transmits and receives data in accordance with at least one wireless Internet technique within a range including Internet techniques which are not listed above. Further, a short range communication technology may include Bluetooth, RFID (radio frequency identification), IrDA (infrared data association), UWB (ultra-wideband), ZigBee, NFC (near field communication), USC (ultra sound communication), VLC (visible light communication), Wi-Fi, Wi-Fi direct or the like. Furthermore, the wired communication technique may include power line communication (PLC), USB communication, Ethernet, serial communication, an optical/coaxial cable, or the like.

The user equipment communication unit 110 may transmit information with any terminal through a universal serial bus (USB).

The user equipment communication unit 110 transmits and receives a wireless signal to and from a base station, the beacon 200, the service providing device 300, the POS terminal 400, and the payment server 500 on a mobile communication network built according to technical standards for mobile communication or communication schemes (for example, global system for mobile communication (GSM), code division multi access (CDMA), code division multi access 2000 (CDMA2000), enhanced voice-data optimized or enhanced voice-data only (EV-DO), wideband CDMA (WCDMA), high speed downlink packet access (HSDPA), high speed uplink packet access (HSUPA), long term evolution (LTE), long term evolution-advanced (LTE-A), or the like).

Further, the user equipment communication unit 110 receives identification information (or unique identification information of a store equipped with the beacon 200) of the beacon 200 which is transmitted from the beacon 200, by the control of the user equipment control unit 150.

The user equipment storing unit 120 stores various user interfaces UI and graphic user interfaces GUI.

Further, the user equipment storing unit 120 stores data and programs required to operate the user equipment 100.

That is, the user equipment storing unit 120 may store a plurality of application programs (or applications) which are driven in the user equipment 100 and data and commands for operation of the user equipment 100. At least some of the application programs may be downloaded from an external service providing device through wireless communication. Further, at least some of the application programs may be provided on the user equipment 100 since a releasing time in order to support a basic function (for example, phone call receiving and sending functions, message receiving and transmitting functions) of the user equipment 100. In the meantime, the application program is stored in the user equipment storing unit 120 and provided in the user equipment 100 to be driven to perform an operation (or a function) of the user equipment 100 by the user equipment control unit 150.

Further, the user equipment storing unit 120 may include at least one storing medium of a flash memory type, a hard disk type, a multimedia card micro type, a card type memory (for example, an SD or XD memory), a magnetic memory, a magnetic disk, an optical disk, a random access memory (RAM), a static random access memory (SRAM), a read-only memory (ROM), an electrically erasable programmable read-only memory (EEPROM), and a programmable read-only memory (PROM). Further, the user equipment 100 may operate a web storage which performs a storing function of the user equipment storing unit 120 on the Internet or operate in association with the web storage.

Further, the user equipment storing unit 120 stores identification information (or unique identification information of a store equipped with the beacon 200) of the beacon 200 which is received through the user equipment communication unit 110, by the control of the user equipment control unit 150.

The user equipment display unit 130 may display various contents such as various menu screens using a user interface and/or graphic user interface stored in the user equipment storing unit 120, by the control of the user equipment control unit 150. Here, the contents displayed on the user equipment display unit 130 may include a menu screen including various texts, image data (including various information data), and data such as icons, list menus, or a combo boxes. The user equipment display unit 130 may be a touch screen.

Further, the user equipment display unit 130 may include at least one of a liquid crystal display (LCD), a thin film transistor liquid crystal display (TFT LCD), an organic light emitting diode (OLED), a flexible display, a three dimensional display (3D display), an e-ink display, and a light emitting diode (LED).

Further, the user equipment display unit 130 may be configured as a stereoscopic display unit which displays a stereoscopic image.

A 3D display scheme such as a stereoscopic type (a glass type), an auto stereoscopic type (a glassless type), or a projection scheme (a holographic type) may be applied to the stereoscopic display unit.

Further, the user equipment display unit 130 displays identification information (or unique identification information of a store equipped with the beacon 200) of the beacon 200 which is received through the user equipment communication unit 110, by the control of the user equipment control unit 150.

The user equipment voice output unit 140 outputs voice information included in a signal processed by the user equipment control unit 150. Here, the user equipment voice output unit 140 may include a receiver, a speaker, a buzzer, and the like.

Further, the user equipment voice output unit 140 outputs a guide voice generated by the user equipment control unit 150.

Further, the user equipment voice output unit 140 outputs voice information corresponding to identification information (or unique identification information of a store equipped with the beacon 200) of the beacon 200 which is received through the user equipment communication unit 110, by the control of the user equipment control unit 150.

The user equipment control unit 150 performs an overall control function of the user equipment 100.

The user equipment control unit 150 performs an overall control function of the user equipment 100 using a program and data stored in the user equipment storing unit 120. The user equipment control unit 150 may include a RAM, a ROM, a CPU, a GPU, and a bus and the RAM, the ROM, the CPU, and the GPU are connected to each other through the bus. The CPU accesses the user equipment storing unit 120 to perform booting using an O/S stored in the user equipment storing unit 120 and performs various operations using various programs, contents, and data stored in the user equipment storing unit 120.

Further, the user equipment control unit 150 interlocks with the service providing device 300 to perform a member joining procedure for the user of the user equipment 100.

When the member joining procedure is performed, the user equipment control unit 150 normally completes the member joining procedure for the service providing device 300 only by completing the authentication function through a self-authentication unit (for example, including a mobile phone, a credit card, I-PIN, e-mail, and the like).

Further, when a user who carries the user equipment 100 enters a store, the user equipment control unit 150 controls the user equipment communication unit 110 to receive the identification information (or unique identification information of a store equipped with the beacon 200) of the beacon 200 transmitted from the beacon 200.

Further, the user equipment control unit 150 transmits the received unique identification information of the beacon 200 (or the unique identification information of a store equipped with the beacon 200) and identification information of the user equipment 100 to the service providing device 300 through the user equipment communication unit 110. Here, the identification information of the user equipment 100 includes a mobile directory number (MDN), a mobile IP, a mobile MAC, a subscriber identify module (Sim) card unique information, and a serial number.

Further, when a user of the user equipment control unit 150 is not a member who is registered in advance in the service providing device 300, the user equipment control unit 150 performs the member joining procedure for the user equipment 100 (or a user of the user equipment 100) based on guide information related with the member joining procedure provided from the service providing device 300.

Further, when the user of the user equipment control unit 150 is a member who is registered in advance in the service providing device 300, the user equipment control unit 150 receives one or more advertisement information, one or more benefit information, or a recommended card list transmitted from the service providing device 300 in response to the transmitted unique identification information (or unique identification information of a store equipped with the beacon 200) of the beacon 200 and the identification information of the user equipment 100 through the user equipment communication unit 110. Here, the benefit information includes coupon information, membership benefit information, and discount benefit information. Further, the recommended card list includes at least one card to which the benefit information is applied, among a plurality of cards (or one or more cards) which is issued in advance to the user equipment 100.

Further, the user equipment control unit 150 outputs at least one of the received advertisement information, benefit information, and recommended card list through the user equipment display unit 130 and/or the user equipment voice output unit 140.

Further, the user equipment control unit 150 checks one payment card (or unique identification information of the payment card) selected from the plurality of payment cards which is registered (or issued) in a specific app which is installed in advance in the user equipment 100.

The user equipment control unit 150 may checks the payment card selected from the recommended card list transmitted from the service providing device 300.

The user equipment control unit 150 may create the recommended card list including at least one card to which the benefit information may be applied, among a plurality of payment cards which is registered in advance in the user equipment 100, based on one or more benefit information provided from the service providing device 300 and display the created recommended card list on the user equipment display unit 130. Further, the user equipment control unit 150 may check one payment card selected from the recommended card list displayed on the user equipment display unit 130.

The user equipment control unit 150 receives a PIN number (personal identification number) in accordance with the user input through a specific app which is installed in advance in the user equipment 100. Here, the PIN number may be a PIN number corresponding to the checked payment card type.

Further, the user equipment control unit 150 transmits the checked payment card type (or unique identification information of the payment card), the PIN number, and the identification information of the user equipment 100 to the service providing device 300 through the user equipment communication unit 110.

The user equipment control unit 150 receives a token transmitted from the service providing device 300 in response to the PIN number which is transmitted in advance, through the user equipment communication unit 110.

The user equipment control unit 150 creates a barcode (or a quick response code (QR code)) including the received token (or token information) and the identification information of the user equipment 100.

The user equipment control unit 150 stores the created barcode (or QR code) in the user equipment storing unit 120.

When a predetermined method is selected as a payment method through a specific app which is installed in advance in the user equipment 100, the user equipment control unit 150 transmits the barcode information (or the QR code information) corresponding to the barcode (or a QR code) which is previously created to the POS terminal 400 through the user equipment communication unit 110. Here, the barcode information corresponding to the barcode (or QR code information corresponding to the QR code) includes the token (or token information) or identification information of the user equipment 100. In this case, the payment method includes cash payment, credit card payment, or electronic payment and the predetermined method may be electronic payment.

As described above, when the user equipment 100 and the POS terminal 400 are connected through a wired/wireless communication scheme, the barcode information (or QR code information) may be transmitted from the user equipment 100 to the POS terminal 400.

In contrast, when the user equipment 100 and the POS terminal 400 are not connected through a wired/wireless communication scheme, if the user of the user equipment 100 selects a payment method which is set in advance through a specific app which is installed in advance in the user equipment 100, a barcode (or a QR code) displayed on the user equipment display unit 130 may be recognized (or scanned/tagged) by the POS terminal 400.

Further, after performing a payment function on one or more products to be paid which are selected by a user of the user equipment 100 based on the barcode information (or the QR code information) which is previously transmitted, the user equipment control unit 150 receives a payment function performing result transmitted from the POS terminal 400 (or the service providing device 300) through the user equipment communication unit 110 in response to the barcode information (or the QR code information) which is previously transmitted.

Further, the user equipment control unit 150 outputs the received payment function performing result through the user equipment display unit 130 and/or the user equipment voice output unit 140.

Further, the user equipment 100 may further include an interface unit (not illustrated) which functions as an interface with all external apparatuses which are connected to the user equipment 100. For example, the interface unit may be configured by a wired/wireless headset port, an external charger port, a wired/wireless data port, a memory card port, a port connecting devices with identification modules, an audio input/output (I/O) port, a video input/output (I/O) port, an earphone port, and the like. Here, the identification module is a chip which stores various information for authenticating a permission of the user equipment 100 and may include a user identity module (UIM), a subscriber identity module (SIM), a universal subscriber identity module (USIM), and the like. Further, the device equipped with the identification module may be prepared in a smart card form. Accordingly, the identification module may be connected with the user equipment 100 through the port. Such an interface unit receives data or power from an external device to transmit the received data or power to each component in the user equipment 100 or transmit the data in the user equipment 100 to the external device.

Further, the interface unit may be a passage through which the power from a cradle is supplied to the corresponding user equipment 100 when the user equipment 100 is connected to an external cradle or a passage through which various command signals input from the cradle by the user is transferred to the corresponding user equipment 100. Various command signals input from the cradle or the corresponding power may also operate by a signal for recognizing that the user equipment 100 is accurately installed on the cradle.

Further, the user equipment 100 may further include an input unit (not illustrated) for receiving a signal according to a button operation of the user or any function selection or receiving a command or a control signal created by an operation such as an operation of touching/scrolling the displayed screen.

The input unit is a means for receiving at least one of a user's command, selection, data, and information and may include a plurality of input keys and function keys for receiving figure or text information and setting various functions.

Further, the input unit may use various devices such as a key pad, a dome switch, a touch pad (a pressure resistive type/a capacitive type), a touch screen, a jog wheel, a jog switch, a jog shuttle, a mouse, a stylus pen, and a touch pen. Particularly, when the user equipment display unit 130 is formed in a touch screen form, some or all of the input functions may be performed by the user equipment display unit 130.

Further, each component unit (or each module) of the user equipment 100 may be software stored on a memory (or the user equipment storing unit 120) of the user equipment 100. The memory may be an internal memory of the user equipment 100 and may an external memory or other types of storing devices. Further, the memory may be a non-volatile memory. The software stored on the memory may include a command set to allow the user equipment 100 to perform a specific operation while executing.

The beacon 200 communicates with the user equipment 100 and the POS terminal 400.

Further, the beacon 200 receives store information related with the store equipped with the beacon 200 or unique identification information of the store equipped with the beacon 200 transmitted from the POS terminal 400.

The beacon 200 broadcasts (or transmits) store information or the identification information (or unique identification information of the store equipped with the beacon 200) of the beacon 200.

The service providing device 300 communicates with the user equipment 100, the POS terminal 400, and the payment server 500.

The service providing device 300 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

Further, the service providing device 300 interlocks with the user equipment 100 to perform a member joining procedure for the user of the user equipment 100.

Further, the service providing device 300 receives the unique identification information of the beacon 200 and the identification information of the user equipment 100 transmitted from the user equipment 100.

Further, the service providing device 300 determines (or checks) whether the user corresponding to the user equipment 100 is a member who is registered (joined) in advance in the service providing device 300 based on the received identification information of the user equipment 100.

When the user corresponding to the user equipment 100 is not a member who is registered in advance in the service providing device 300 as a determination result (or a checking result), the service providing device 300 transmits guide information related with the member joining procedure to the user equipment 100.

Further, the service providing device 300 interlocks with the user equipment 100 to perform a member joining procedure for the user equipment 100 (or the user of the user equipment 100).

Further, when the user corresponding to the user equipment 100 is a member who is registered in advance in the service providing device 300 as a determination result (or a checking result), the service providing device 300 checks one or more advertisement information and one or more benefit information which may be provided to the user equipment 100 in the store equipped with the beacon 200, among a plurality of advertisement information and a plurality of benefit information which are stored in advance based on the unique identification information of the beacon 200 which is previously received and the identification information of the user equipment 100.

Further, the service providing device 300 creates a recommended card list including one or more recommended cards to which the benefit information may be applied (or reflected) among a plurality of cards issued to the user equipment 100, based on one or more checked benefit information. Here, the benefit information includes coupon information, membership benefit information, and discount benefit information.

The service providing device 300 transmits one or more advertisement information, one or more benefit information, and a recommended card list including one or more recommended cards which may be provided to the user equipment 100 in the store equipped with the checked beacon 200 to the user equipment 100.

That is, when the user corresponding to the user equipment 100 is a member who is registered in advance in the service providing device 300, the service providing device 300 checks store information corresponding to the unique identification information of the beacon 200 among store information for every unique identification information of the plurality of beacons which is stored in advance. Further, the service providing device 300 checks one or more advertisement information and benefit information which may be provided to the user equipment 100 in the store based on the checked store information and the received identification information of the user equipment 100. Further, the service providing device 300 creates the recommended card list including at least one card to which the benefit information is applied, among a plurality of cards (or one or more cards) which is previously issued to the user equipment 100. Further, the service providing device 300 transmits one or more checked advertisement information, one or more checked benefit information, and the created recommended card list to the user equipment 100.

Further, the service providing device 300 receives the payment card type, the PIN number, and the identification information of the user equipment 100 transmitted from the user equipment 100.

Further, the service providing device 300 creates a token (a one-time token, token information, or temporary token) corresponding to the received PIN number. Here, the token is a temporary token and is randomly created corresponding to the PIN number. Further, a usage count or a usage duration may be set in advance. In this case, the service providing device 300 may create a token corresponding to the received PIN number and the payment card type.

Further, the service providing device 300 manages (or stores) the created token by interlocking with the payment card type, the PIN number, and the identification information of the user equipment 100.

Further, the service providing device 300 transmits the created token (or a token corresponding to the PIN number or a token corresponding to the PIN number and the payment card type) to the user equipment 100.

Further, the service providing device 300 receives the barcode information (or QR code information) transmitted from the payment server 500, to perform the authentication function for the user before performing the payment function on one or more products to be paid which are selected by the user of the user equipment 100.

Further, the service providing device 300 checks whether the token in the barcode information (or the QR code information) is valid, based on the token in the received barcode information (or QR code information) and the identification information of the user equipment 100.

That is, the service providing device 300 checks whether the token in the received barcode information (or QR code information), a token corresponding to the identification information of the user equipment 100, and identification information of the user equipment are included (or present) in the identification information of the user equipment for each of the plurality of tokens stored in advance (or issued in advance).

As described above, the service providing device 300 may verify the validity of the issued token.

When the token in the received barcode information (or QR code information), the token corresponding to the identification information of the user equipment 100, and identification information of the user equipment are not included in the identification information of the user equipment for each of the plurality of tokens which is stored in advance in the service providing device 300 as a checking result, that is, when the token in the received barcode information (or the QR code information) is not valid, the service providing device 300 transmits authentication failure information to the payment server 500.

When the token in the received barcode information (or QR code information), the token corresponding to the identification information of the user equipment 100, and identification information of the user equipment are included in the identification information of the user equipment for each of the plurality of tokens which is stored in advance in the service providing device 300 as a checking result, that is, when the token in the received barcode information (or the QR code information) is valid, the service providing device 300 transmits card information, user information, benefit information, and the like corresponding to the identification information of the user equipment 100 in the received barcode information (or QR code information) to the payment server 500. In this case, the service providing device 300 may transmit card information, user information, and benefit information corresponding to the payment card type related with a valid token (or the payment card type checked based on the token created corresponding to the PIN number and the payment card type/PIN number is managed by interlocking with the token, payment card type, and payment card type checked based on the identification information of the user equipment) to the payment server 500. Here, the card information includes a card number, an expiration date, a card verification code (CVC) number, and a user name. The user information includes a user name, birth date, an address, and an image. Further, the benefit information includes coupon information, membership benefit information, and discount benefit information.

That is, when the token in the received barcode information (or QR code information) is valid as the checking result, the service providing device 300 checks the card information, the user information, and the benefit information stored in advance in the service providing device 300 related with the user (or the user equipment 100) corresponding to the identification information of the user equipment 100 in the received barcode information (or QR code information) and transmits the checked card information, user information, and benefit information to the payment server 500. In this case, the service providing device 300 checks the card information, the user information, and the benefit information corresponding to the payment card type which is previously transmitted from the user equipment 100 and transmits the checked card information, user information, and benefit information to the payment server 500.

Further, the service providing device 300 receives a payment function performed result (or payment information) transmitted from the payment server 500.

Further, the service providing device 300 stores the received payment function performed result by interlocking with the identification information of the user equipment 100.

Further, the service providing device 300 may transmit the received payment function performed result to the user equipment 100 corresponding to the identification information of the user equipment 100.

Further, the service providing device 300 may be implemented in a form such as a web server, a database server, and a proxy server. Further, in the service providing device 300, one or more of various software which allows a network load distribution mechanism or a service providing device 300 to operate on the Internet or other networks may be installed, and as a result, the service providing device 300 may be implemented by a computerized system. Further, the network may be an http network and may be a private line, Intranet, or any other networks. Furthermore, the service providing device 300 and the user equipment 100 may be connected to each other by a security network so as to suppress the data from being attacked by any hacker or other third parties. Further, the service providing device 300 may include a plurality of database servers. The database server may be implemented to be separately connected with the service providing device 300 through any type of network connection including a distributed database server architecture.

A processor mounted in the user equipment 100 or the service providing device 300 according to the exemplary embodiment of the present invention may process the program command to execute the method according to the exemplary embodiment of the present invention. In an implemented embodiment, the processor may be a single-threaded processor. In another implemented embodiment, the processor may be a multi-threaded processor. Further, the processor may process the command stored on the memory or the storing device.

The point of sales (POS) terminal 400 communicates with the user equipment 100, the beacon 200, the service providing device 300, and the payment server 500.

Further, the POS terminal 400 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

Further, the POS terminal 400 transmits store information related with the store equipped with the beacon 200 or unique identification information of the store equipped with the beacon 200 to the beacon 200.

The POS terminal 400 scans (or recognizes a barcode attached on a product to be paid) one or more products (or payment products) to be paid which are selected by the user of the user equipment 100.

The POS terminal 400 displays product information on one or more scanned (or recognized) products to be paid. Here, the product information includes a product name, a unique product code, a unit price, an amount, a price, a total price, and the like.

In contrast, when the user equipment 100 and the POS terminal 400 are not connected through a wired/wireless communication scheme, if the user of the user equipment 100 selects a payment method which is previously set through a specific app which is installed in advance in the user equipment 100, the POS terminal 400 recognizes (or scans/tags) a barcode (or a QR code) displayed on the user equipment 100.

Further, the POS terminal 400 receives the barcode information (or the QR code information) transmitted from the user equipment 100.

When the POS terminal 400 recognizes a barcode (or a QR code) displayed on the user equipment 100, the POS terminal 400 checks the recognized barcode information (or the QR code information).

The POS terminal 400 displays or stores the received (or checked) barcode information (or QR code information).

The POS terminal 400 transmits information on one or more products to be paid (or recognized product information to be paid), barcode information (or QR code information), and the identification information of the POS terminal 400 to the payment server 500.

The POS terminal 400 may receive authentication failure information transmitted from the payment server 500 in response to the barcode information (or QR code information) transmitted to the payment server 500.

The POS terminal 400 displays the received authentication failure information.

Further, the POS terminal 400 may transmit the received authentication failure information to the user equipment 100.

Further, the POS terminal 400 receives user information transmitted from the payment server 500 immediately before performing a payment function on one or more products selected by the user of the user equipment 100 based on the barcode information (or QR code information) transmitted to the payment server 500. Here, the user information includes a user name, birth date, address, and an image related with the user corresponding to the identification information of the user equipment 100.

The POS terminal 400 displays the received user information.

Further, the user of the POS terminal 400 checks an image in the user information displayed on the POS terminal 400 and the user of the user equipment 100 which makes a payment on the product. Thereafter, when the image in the user information matches the user of the user equipment 100, the POS terminal 400 receives information indicating the user matching in accordance with the user input of the POS terminal 400.

The POS terminal 400 transmits received information indicating the users matching, and identification information of the POS terminal 400 to the payment server 500.

Further, when a payment function on one or more products selected by the user of the user equipment 100 is normally performed based on the barcode information (or QR code information) transmitted to the payment server 500, the POS terminal 400 receives a payment function performed result (or payment information) which is transmitted from the payment server 500 in response to the barcode information (or the QR code information) transmitted to the payment server 500. Here, the payment function performed result (or the payment information) includes a product name, a unique product code, a unit price, an amount, a discounted price, whether to apply a coupon, a price, a total price, payment date and time information, and a payment card type.

The POS terminal 400 transmits the received payment function performed result to the user equipment 100.

Further, the POS terminal 400 may output the received payment function performed result through a printed matter such as a receipt.

The payment server 500 communicates with the user equipment 100, the service providing device 300, and the POS terminal 400.

Further, the payment server 500 may include a communication unit (not illustrated), a storing unit (not illustrated), a display unit (not illustrated), a voice output unit (not illustrated), and a control unit (not illustrated) corresponding to the user equipment communication unit 110, the user equipment storing unit 120, the user equipment display unit 130, the user equipment voice output unit 140, the user equipment control unit 150 included in the user equipment 100, respectively.

The payment server 500 receives information on one or more products to be paid (or recognized product information to be paid), barcode information (or QR code information), and the identification information of the POS terminal 400 transmitted from the POS terminal 400.

Further, the payment server 500 transmits the received barcode information (or QR code information) to the service providing device 300 in order to perform an authentication procedure related with the user equipment 100.

When the token in the barcode information (or the QR code information) which is transmitted to the service providing device 300 is not valid, the payment server 500 receives authentication failure information which is transmitted from the service providing device 300 in response to the barcode information (or the QR code information) which is transmitted to the service providing device 300.

Further, the payment server 500 transmits the received authentication failure information to the POS terminal 400.

When the token in the barcode information (or the QR code information) which is transmitted to the service providing device 300 is valid, the payment server 500 receives card information, user information, or benefit information (or card information, user information, or benefit information corresponding to the identification information of the user equipment 100 in the barcode information (or the QR code information)) which is transmitted from the service providing device 300 in response to the barcode information (or the QR code information) which is transmitted to the service providing device 300.

The payment server 500 performs a payment function on the payment amount corresponding to one or more product information to be paid based on the received card information, user information, and benefit information. In this case, the payment server 500 may perform a payment function on a payment amount obtained by applying a benefit amount corresponding to the benefit information transmitted from the service providing device 300 (or benefit information which may be applied to the user of the user equipment 100) to price information on one or more products to be paid.

In this case, immediately before performing the payment function, the payment server 500 transmits the user information transmitted from the service providing device 300 to the POS terminal 400.

When the image in the user information does not match the user of the user equipment 100 who make a payment on the product, the payment server 500 transmits payment cancel information on the one or more product information to the POS terminal 400 or performs the payment function after performing additional authentication procedure on the user equipment 100.

When the image in the user information matches the user of the user equipment 100 who make a payment on the product, the payment server 500 receives the information indicating that the user matches the image transmitted from the POS terminal 400 and the identification information of the POS terminal 400, in response to the user information transmitted to the POS terminal 400.

The payment server 500 performs a payment function on the payment amount corresponding to one or more product information to be paid based on the received card information, user information, benefit information, and the information indicating that the user matches the image.

The payment server 500 transmits the payment function performed result (or payment information) to the POS terminal 400 and the service providing device 300. Here, the payment function performed result (or the payment information) includes a product name, a unique product code, a unit price, an amount, a discounted price, whether to apply a coupon, a price, a total price, payment date and time information, and a payment card type.

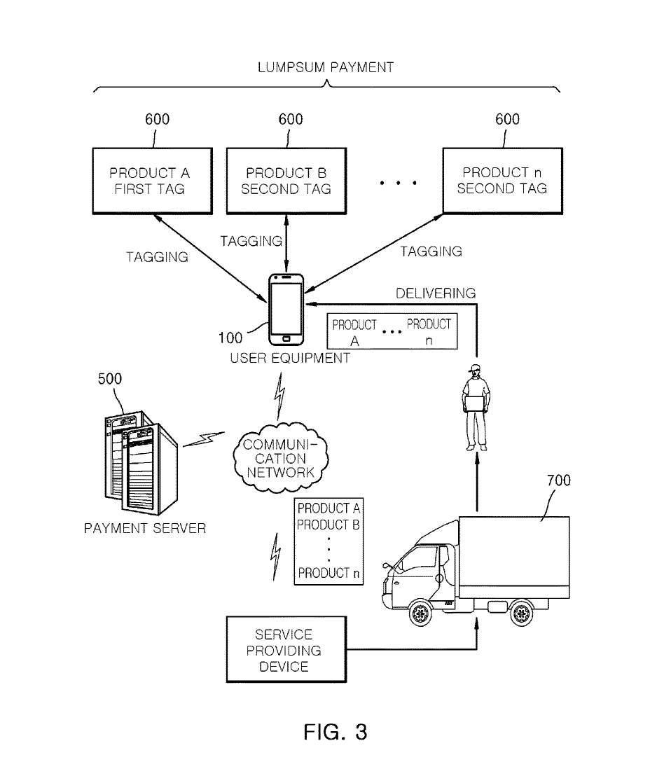

FIG. 3 is a block diagram illustrating a configuration of a payment system 10 according to another exemplary embodiment of the present invention.

As illustrated in FIG. 3, a payment system 10 is configured by user equipment 100, a plurality of product related NFC tags 600, a service providing device 300, a payment server 500, and a delivery vehicle 700. However, all the components of the payment system 10 illustrated in FIG. 3 are not essential components, but the payment system 10 may be implemented by more components or less components than the components illustrated in FIG. 3.

When an NFC tag is tagged in the user equipment 100, the user equipment 100 checks whether a product corresponding to identification information of the tagged NFC tag 600 is included, among one or more products corresponding to the identification information of one or more NFC tags 600 which are being delivered in related with the user equipment 100. When the product corresponding to the identification information of the tagged NFC tag 600 is included among one or more products corresponding to the identification information of one or more NFC tags 600 which are being delivered, as a checking result, the user equipment 100 interlocks with the service providing device 300 to check position information/delivering status of the delivery vehicle 700 which is delivering the product and display the checked position information/delivering status of the delivery vehicle 700.

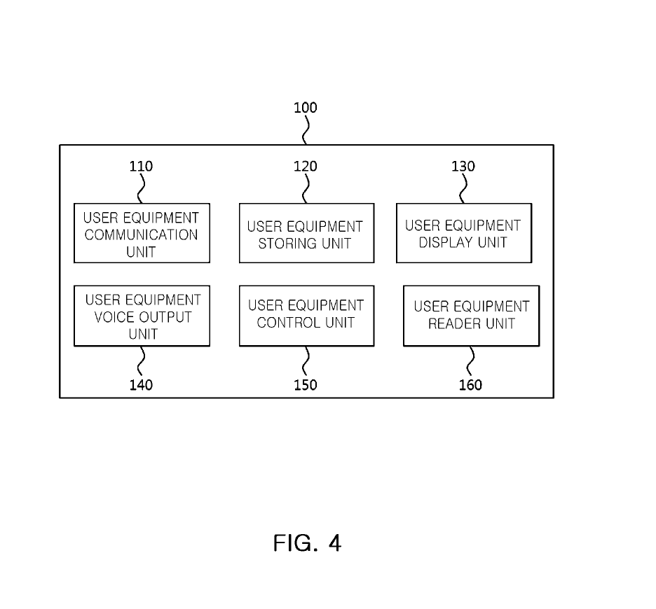

As illustrated in FIG. 4, the user equipment 100 is configured by a user equipment communication unit 110, a user equipment storing unit 120, a user equipment display unit 130, a user equipment voice output unit 140, a user equipment control unit 150, and a user equipment reader unit 160.

The user equipment storing unit 120 stores one or more products (or product information) corresponding to identification information of one or more NFC tags 600 which are previously purchased by the user equipment 100 and are being delivered.

The user equipment reader unit 160 tags (or recognizes) the tag (for example, including an NFC tag and a RFID tag).

Further, the user equipment reader unit 160 provides information (for example, including product information related with the tag) in accordance with the tagging to the user equipment control unit 150.

When the user equipment reader unit 160 tags an arbitrary NFC tag 600, the user equipment control unit 150 displays product information related with the NFC tag 600 on the user equipment display unit 130 in accordance with the tagging of the NFC tag through a dedicated app or a web service which is installed in advance in the user equipment 100. Here, the NFC tag 600 contains (or stores) product information related with one or more products and may be related with a product which is repeatedly purchased by the user of the user equipment 100.

In this case, the product information related with the NFC tag 600 may be product information of the cheapest product among searching results in a predetermined shopping mall site (for example, including “11 street”) with respect to a specific product related with the NFC tag 600.

Further, the searching results in one or more shopping mall sites (for example, including “11 street”) with respect to a specific product related with the NFC tag 600 are displayed on the user equipment display unit 130 and the product information related with the NFC tag 600 may be product information of a product selected from the one or more searching results displayed on the user equipment display unit 130.

Further, the user equipment control unit 150 displays the product information related with the NFC tag 600 on the user equipment display unit 130 and also automatically adds (or stores) the related product (or related product information) in a cart item of the dedicated app or the web service.

Further, the user equipment control unit 150 checks (or determines) whether the tagging of the NFC tag is completed.

That is, the user equipment control unit 150 checks whether the tagging is performed on another NFC tag 600 within a predetermined time (for example, within 10 seconds) or whether a NFC tag 600 including predetermined tag completed information is tagged.

As a checking result (or determination result), when the tagging of the NFC tag is not completed, that is, a tagging function on another NFC tag 600 is continuously performed, the user equipment control unit 150 repeatedly performs the previous steps to cumulatively store one or more product information related with the repeatedly purchased product in the cart item.

As a checking result (or determination result), when the tagging of the NFC tag is completed, that is, a tagging function on another NFC tag 600 is not performed, the user equipment control unit 150 interlocks with the service providing device 300 and the payment server 500 to perform a payment function in accordance with a lump sum ordering function on one or more products related with one or more product information stored in the cart item of the user equipment 100. In this case, the user equipment 100 may perform the payment function in accordance with the lump sum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment control unit 150 receives a payment function performed result in accordance with the performing of a payment function provided from the service providing device 300 (or the payment server 500) through the user equipment communication unit 110. Here, the payment function performed result (or the payment information) includes one or more product names, a unique product code, a unit price, an amount, a discounted price, whether to apply a coupon, a price, a total price, payment date and time information, and a payment card type.

Further, the user equipment control unit 150 outputs the received payment function performing result through the user equipment display unit 130 and/or the user equipment voice output unit 140.

Further, the user equipment control unit 150 may output the payment function performed result transmitted from the payment server 500 through the shopping web site which is provided from the service providing device 300.

When the user equipment reader unit 160 tags an arbitrary NFC tag 600, the user equipment control unit 150 executes a dedicated app which is installed in advance in the user equipment 100 and displays an app executing result screen on the user equipment display unit 130.

When the user equipment reader unit 160 tags an arbitrary NFC tag 600, the user equipment control unit 150 accesses a shopping web site which is provided from the service providing device 300 through the user equipment communication unit 110 and displays a screen which is provided from the shopping web site on the user equipment display unit 130.

Further, the user equipment control unit 150 checks (or determines) whether a product corresponding to the identification information of the tagged NFC tag 600 is included among one or more products corresponding to the identification information of one or more NFC tags 600 which are being delivered, related with the user equipment 100 through the executed app or web service (or stored in the executed app/stored in the user equipment storing unit 120).

That is, when the user equipment reader unit 160 tags an arbitrary NFC tag 600, the user equipment control unit 150 checks (or determines) whether a product corresponding to the identification information of the tagged NFC tag 600 is included, among one or more products corresponding to the identification information of the one or more NFC tags 600 which are ordered in the user equipment 100 (or among one or more products corresponding to the identification information of one or more NFC tags 600 which have been ordered in the user equipment 100 but have not been delivered).

As a checking result (or a determination result), when a product corresponding to the identification information of the tagged NFC tag 600 is included among one or more products corresponding to the identification information of one or more NFC tags 600 which are being delivered, related with the user equipment 100 through the dedicated app or web service which is installed in advance in the user equipment 100, the user equipment control unit 150 interlocks with the service providing device 300 to check position information (or a delivering status/a delivering status in accordance with the position information) of a delivery vehicle 700 which is delivering the product corresponding to the identification information of the tagged NFC tag 600 (or a terminal (not illustrated) carried by a delivery man who takes the delivery vehicle 700 which is delivering the product) and output the checked position information (or the delivering status) of the delivery vehicle 700 through the user equipment display unit 130 and/or the user equipment voice output unit 140.

Further, as a checking result (or a determination result), when a product corresponding to the identification information of the tagged NFC tag 600 is included among one or more products corresponding to the identification information of one or more NFC tags 600 which are ordered in the user equipment 100 (or one or more products corresponding to the identification information of the one or more NFC tags 600 which are ordered in the user equipment 100 but have not been delivered), the user equipment control unit 150 interlocks with the service providing device 300 to check position information (or a delivering status/a delivering status in accordance with the position information) of a delivery vehicle 700 which is delivering the product corresponding to the identification information of the tagged NFC tag 600 and output the checked position information (or the delivering status) of the delivery vehicle 700 through the user equipment display unit 130 and/or the user equipment voice output unit 140.

That is, as a checking result (or a determination result), when a product corresponding to the identification information of the tagged NFC tag 600 is included among one or more products corresponding to the identification information of one or more NFC tags 600 which are being delivered related with the user equipment 100 through the dedicated app or web service which is installed in advance in the user equipment 100, the user equipment control unit 150 transmits an invoice number related with the product corresponding to the identification information of one or more NFC tags which is being delivered and the identification information of the user equipment 100 to the service providing device 300 through the user equipment communication unit 110. Here, the identification information of the user equipment 100 includes a mobile directory number (MDN), a mobile IP, a mobile MAC, a subscriber identify module (Sim) card unique information, and a serial number.

Further, the user equipment control unit 150 receives position information (or a delivering status/a delivering status in accordance with the position information) of the delivery vehicle 700 which is delivering the product corresponding to the identification information of the tagged NFC tag 600 (or a terminal (not illustrated) carried by a delivery man who takes the delivery vehicle 700 which is delivering the product), transmitted from the service providing device 300 in response to the transmission of the invoice number, through the user equipment communication unit 110.

Further, the user equipment control unit 150 outputs position information (or a delivering status/a delivering status in accordance with the position information) of the delivery vehicle 700 which is delivering the product corresponding to the identification information of the received tagged NFC tag 600 (or a terminal (not illustrated) carried by a delivery man who takes the delivery vehicle 700 which is delivering the product), through the user equipment display unit 130 and/or the user equipment voice output unit 140.

Further, as a checking result (or a determination result), when a product corresponding to the identification information of the tagged NFC tag 600 is not included among one or more products corresponding to the identification information of one or more NFC tags 600 which are being delivered related with the user equipment 100 through the dedicated app or web service which is installed in advance in the user equipment 100 or when the NFC tag 600 is tagged but there is no product which is being delivered related with the user equipment 100, the user equipment control unit 150 displays the product information related with the NFC tag 600 which is previously tagged through the executing dedicated app or the web service on the user equipment display unit 130. Here, the NFC tag 600 may include product information related with one or more products.

That is, as a checking result (or a determination result), when the product corresponding to the identification information of the tagged NFC tag 600 is not being delivered, the user equipment control unit 150 displays the product information related with the tagged NFC tag 600 on the user equipment display unit 130.

In this case, the product information related with the NFC tag 600 may be product information of the cheapest product among searching results in a predetermined shopping mall site (for example, including “11 street”) with respect to a specific product related with the NFC tag 600.

Further, the searching results in one or more shopping mall sites (for example, including “11 street”) with respect to a specific product related with the NFC tag 600 are displayed on the user equipment 100 and the product information related with the NFC tag 600 may be product information of a product selected from the one or more searching results displayed on the user equipment 100.

Further, the user equipment control unit 150 displays the product information related with the NFC tag 600 and also automatically adds (or stores) the related product (or related product information) in a cart item of the dedicated app or the web service.

Further, as a checking result (or a determination result), when a product corresponding to the identification information of the tagged NFC tag 600 is not included among one or more products corresponding to the identification information of the one or more NFC tags 600 which are ordered in the user equipment 100 (or among one or more products corresponding to the identification information of one or more NFC tags 600 which have been ordered in the user equipment 100 but have not been delivered) or when the NFC tag 600 is tagged but there is no product which is being delivered related with the user equipment 100, the user equipment control unit 150 may display the product information related with the NFC tag 600 which is previously tagged through the executing dedicated app or the web service and also automatically store the product information in a cart item.

Further, the user equipment reader unit 160 tries to additionally tag one or more NFC tags 600 and the user equipment control unit 150 automatically adds one or more product information related with the repeatedly purchased product in accordance with the additional tagging in the cart item.

Further, when the additional tagging of the NFC tag is completed, that is, a tagging function on another NFC tag 600 is not performed, the user equipment control unit 150 interlocks with the service providing device 300 and the payment server 500 to perform a payment function in accordance with a lump sum ordering function on one or more products related with one or more product information stored in the cart item of the user equipment 100. In this case, the user equipment control unit 150 checks additional setting information based on the position information (or position information of the user equipment 100 and/or current time information) of the user equipment 100 which is previously checked and performs the payment function through the payment card information in the checked additional setting information. In this case, the user equipment 100 may perform the payment function in accordance with the lump sum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment control unit 150 receives a payment function performed result in accordance with the performing of a payment function provided from the service providing device 300 (or the payment server 500) through the user equipment communication unit 110 and outputs the received payment function performed result through the user equipment display unit 130 and/or the user equipment voice output unit 140.

Further, when a payment function on one or more products is normally completed, the user equipment control unit 150 checks the additional setting information based on the position information (or position information of the user equipment 100 and/or current time information) of the user equipment 100 which is previously checked.

Further, the user equipment control unit 150 transmits the checked additional setting information and the identification information of the user equipment 100 to the service providing device 300 through the user equipment communication unit 110. In this case, the additional setting information includes a delivery address (or delivery information), payment card information, and recommendation criteria (or preference profile).

When a payment function on one or more products is normally completed in the user equipment 100, the user of the user equipment 100 receives one or more products related with one or more product information which are delivered through the service providing device 300. In this case, when one or more products are provided by different companies, the user of the user equipment 100 may receive the products which are individually delivered for every company.

Further, the user of the user equipment 100 receives the product which is delivered from the service providing device 300 (or a company which supplies the product) based on delivery location information which is transmitted from the user equipment 100 to the service providing device 300.

When there are previous purchase histories for individual products, the same purchase is repeated, or the product is researched to select the lowest price, or recommended purchase information (for example, including the lowest price including a delivery fee or the lowest price when a plurality of products is purchased) on a plurality of products is provided. When the user of the user equipment 100 selects one, the payment on the purchase is performed.

When the product is already purchased and an automatic payment option by automatic order is set, the user equipment 100 may make a lump sum payment through simple checking procedure (for example, check whether to input PIN for simple payment).

Further, a start tag for continuous tagging is separately created if necessary or an NFC tag 600 for continuous tagging may be created as a shopping mall tag.

For example, when in the user equipment 100, a 11 street tag is tagged and tags (including an NFC tag) for a diaper, a wet tissue, and a tissue are continuously tagged and then completion is set (for example, including app manipulation completed tag tagging), the user equipment 100 interlocks with the service providing device 300 to search the corresponding products from the 11 street shopping mall to create recommended order information. When the user inputs payment information (for example, in the case of the mobile payment, PIN is simply input), the order (or a payment function is performed) is completed.

Further, when the order is completed as described above, the user may want to know the delivery status of the product. Therefore, when the user tags a tag for an arbitrary product among ordered products, the delivery information on the order including the product may be provided.

That is, the product tag is tagged, the app installed in the user equipment 100 checks whether there are products which are being delivered. When there are products which are being delivered, the delivery status may be displayed. In this case, a process of asking whether to see the delivery status or place a new order may be included.

When there is no product which is being delivered, the user equipment may proceed a single order for the product tag or wait for subsequent tagging for continuous order.

As a result, different order related operations may be performed in accordance with the delivery status, using the same tag.

The NFC tag 600 includes unique identification information.

Further, the NFC tag 600 includes (or stores) product information related with a specific product (or one or more products). In this case, the NFC tag 600 may include product information for every product/brand.

Further, when the NFC tag 600 is tagged by the user equipment reader unit 160 provided in the user equipment 100, the product information included in the NFC tag 600 is provided (or transmitted) to the user equipment 100.

Further, when the identification information of the NFC tag 600 is interlocked, the NFC tag 600 in which information on a specific shopping mall or a specific product is fixed (or included/stored) in advance may be distributed. In this case, a separate maintenance cost for the NFC tag 600 is not generated and it is easy to apply the NFC tag, the cost of the NFC is cheap. Therefore, the NFC tag may be easily distributed and easily checked.

Even though the NFC tag is mainly described in the exemplary embodiment of the present invention, the present invention is not limited thereto and an electronic tag such as an RFID tag may be used in addition to the NFC tag 600.

The service providing device 300 communicates with the user equipment 100 and the payment server 500.

Further, when the tagging of the NFC tag is completed in the user equipment 100, that is, a tagging function on another NFC tag 600 is not performed in the user equipment 100, the service providing device 300 interlocks with the user equipment 100 and the payment server 500 to perform a payment function in accordance with a lump sum ordering function on one or more products related with one or more product information stored in the cart item of the user equipment 100.

When the payment function is not normally performed, the service providing device 300 transmits payment function failure information to the user equipment 100. The user equipment 100 receives the payment function failure information transmitted from the service providing device 300 and displays the received payment function failure information.

When the payment function is normally performed, the service providing device 300 transmits a payment function performed result transmitted from the payment server 500 to the user equipment 100. Here, the payment function performed result (or the payment information) includes one or more product names (or at least one product name), a unique product code, a unit price, an amount, a discounted price, whether to apply a coupon, a price, a total price, payment date and time information, and a payment card type.

When the payment function is normally performed, the service providing device 300 receives additional setting information transmitted from the user equipment 100 and the identification information of the user equipment 100. In this case, the additional setting information includes a delivery address (or delivery information), payment card information, and recommendation criteria (or preference profile).

Further, when the payment function on one or more products is normally completed in the user equipment 100, the service providing device 300 performs a delivery function on one or more products related with the one or more product information through the delivery device 700 based on the delivery information which is stored in advance related with the user equipment 100. In this case, when one or more products are provided by different companies, the service providing device 300 may perform the delivery function on the products for every company.

Further, when the payment function on one or more products is normally completed in the user equipment 100, the service providing device 300 performs a delivery function on one or more products (or at least one product related with at least one product information) related with the one or more product information through the delivery device 700 based on the delivery address (or delivery information) in the additional setting information transmitted from the user equipment 100.

Further, when a product corresponding to the identification information of the tagged NFC tag 600 is included among one or more products corresponding to the identification information of one or more NFC tags 600 which are being delivered related with the user equipment 100 through the dedicated app or web service which is installed in advance in the user equipment 100, the service providing device 300 receives an invoice number related with the product corresponding to the identification information of one or more NFC tags 600 which are being delivered, transmitted from the user equipment 100 and the identification information of the user equipment 100.

Further, the service providing device 300 checks the position information of a delivery vehicle 700 which is delivering the product corresponding to the invoice number, among a plurality of delivery vehicles 700.

Further, the service providing device 300 checks the delivery status in accordance with the checked position information of the delivery vehicle 700.

Further, the service providing device 300 transmits position information (or a delivering status/a delivering status in accordance with the position information) of the delivery vehicle 700 which is delivering the product corresponding to the identification information of the tagged NFC tag 600 (or a terminal (not illustrated) carried by a delivery man who takes the delivery vehicle 700 which is delivering the product) in response to the invoice number transmitted from the user equipment 100.

The payment server 500 communicates with the user equipment 100 and the service providing device 300.

Further, when the tagging of the NFC tag is completed in the user equipment 100, that is, a tagging function on another NFC tag 600 is not performed in the user equipment 100, the payment server 500 interlocks with the user equipment 100 and the service providing device 300 to perform a payment function in accordance with a lump sum ordering function on one or more products related with one or more product information stored in the cart item of the user equipment 100. In this case, the payment server 500 may perform a payment function on a payment amount obtained by applying a benefit amount corresponding to the benefit information transmitted from the service providing device 300 (or benefit information which may be applied to the user of the user equipment 100) to price information on one or more products to be paid.

When the payment function is not normally performed, the payment server 500 transmits payment function failure information to the user equipment 100 through the service providing device 300. The user equipment 100 receives the payment function failure information transmitted from the service providing device 300 and displays the received payment function failure information.

Further, the payment function is normally performed, the payment server 500 transmits the payment function performed result to the service providing device 300.

The delivery vehicle (or a delivery device) 700 actually performs the delivery function by the management of the service providing device 300.

That is, the delivery man in the delivery vehicle 700 performs a function of delivering at least one product to a user of the user equipment 100 which normally performs the payment function by the engagement of the service providing device 300. In this case, a real-time position of the delivery vehicle 700 (or a delivery man related with the delivery vehicle 700) may be checked by the service providing device 300.

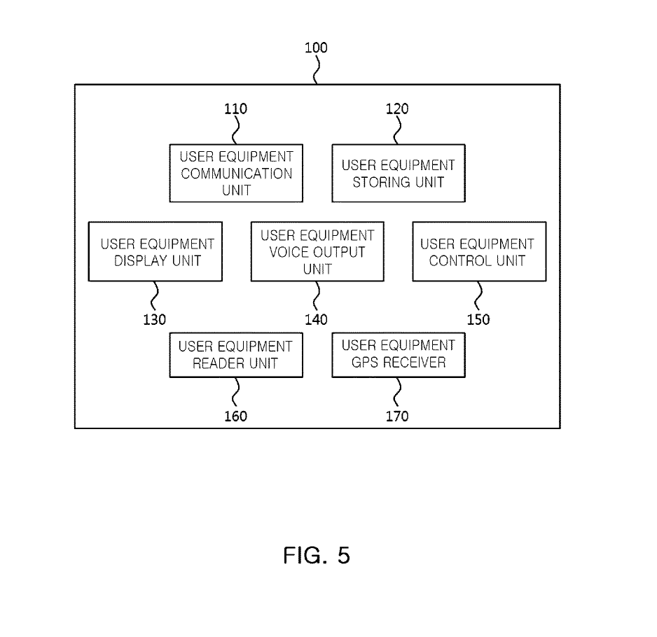

As illustrated in FIG. 5, the user equipment 100 is configured by a user equipment communication unit 110, a user equipment storing unit 120, a user equipment display unit 130, a user equipment voice output unit 140, a user equipment control unit 150, a user equipment reader unit 160, and a user equipment GPS receiver 170.

The user equipment reader unit 160 tags (or recognizes) the tag (for example, including an NFC tag and a RFID tag).

Further, the user equipment reader unit 160 provides information (for example, including product information related with the tag) in accordance with the tagging to the user equipment control unit 150.

The user equipment GPS receiver 170 receives a GPS signal transmitted from the satellite and generates (or creates/checks) position data of the user equipment 100 at real time based on a longitude coordinate and a latitude coordinate included in the received GPS signal. The generated position data is defined as the current position (or current position data) of the user equipment 100. Here, the position information may be received through Wi-Fi or Wibro communication in addition to the user equipment GPS receiver 170.

Further, the signal received through the user equipment GPS receiver 170 may be configured to provide position information of the terminal to the user equipment 100 using a wireless communication scheme such as 802.11 which is a standard of a wireless network of a wireless LAN suggested in institute of electrical and electronics engineers (IEEE) and a wireless LAN including some of infrared communication, 802.15 which is a standard of a wireless personal area network (PAN) including Bluetooth, UWB, and ZigBee, 802.16 which is a standard of wireless metropolitan area network (MAN) including fixed wireless access (FWA) and broadband wireless access (BWA), and 802.20 which is a standard for mobile Internet of mobile broadband wireless access (MBWA) including Wibro and WiMAX.

The user equipment control unit 150 may set the unique identification information of the NFC tag 600 tagged in the user equipment 100 and at least one product information purchased through the user equipment 100 to interlock with each other. In this case, at least one product information may include product information related with the unique identification information of the tagged NFC tag 600.

That is, the user equipment control unit 150 stores the information on at least one product purchased by the user equipment 100 and identification information of the NFC tag 600 corresponding to any one of product information among at least one product information in the user equipment storing unit 120 to interlock with each other.

When the user equipment reader unit 160 tags an arbitrary NFC tag 600, the user equipment control unit 150 executes a dedicated app which is installed in advance in the user equipment 100 and displays an app executing result screen on the user equipment display unit 130.

When the user equipment reader unit 160 tags an arbitrary NFC tag 600, the user equipment control unit 150 accesses a shopping web site which is provided from the service providing device 300 through the user equipment communication unit 110.

Further, the user equipment control unit 150 checks the current position information of the user equipment 100 which is checked through the user equipment GPS receiver 170.

Further, the user equipment control unit 150 determines (or checks) whether the identification information of the tagged arbitrary NFC tag is included among the unique identification information of the NFC tag which interlocks with the purchased product information (or at least one purchased product information).

Further, the user equipment control unit 150 may determine whether the product information related with the previously tagged arbitrary NFC tag is included among the unique identification information of the NFC tag and the purchased product information which are interlocked in advance.

As a determination result (or as a checking result), when the identification information of the previously tagged NFC tag is not included among the unique identification information of the NFC tag which interlocks with the purchased product information, the user equipment control unit 150 displays the product information related with the previously tagged NFC tag 600 on the user equipment display unit 130 through the executing dedicated app or the web service. Here, the NFC tag 600 may include product information related with one or more products.

Further, the user equipment control unit 150 displays the product information related with the NFC tag 600 and also automatically adds (or stores) the related product (or related product information) in a cart item of the dedicated app or the web service.

As a determination result (or as a checking result), when product information related with the previously tagged NFC tag is not included among the unique identification information of the NFC tag and the purchased product information which are interlocked in advance, the user equipment control unit 150 displays the product information related with the previously tagged NFC tag 600 through the executing dedicated app or the web service and also stores the product information in the cart item.

Further, the user equipment reader unit 160 tries to additionally tag one or more NFC tags 600 and the user equipment control unit 150 automatically adds one or more product information related with the repeatedly purchased product in accordance with the additional tagging in the cart item.

Further, when the additional tagging of the NFC tag is completed, that is, a tagging function on another NFC tag 600 is not performed, the user equipment 100 interlocks with the service providing device 300 and the payment server 500 to perform a payment function in accordance with a lump sum ordering function on one or more products related with one or more product information stored in the cart item of the user equipment 100. In this case, the user equipment 100 checks additional setting information based on the position information (or position information of the user equipment 100 and/or current time information) of the user equipment 100 which is previously checked and performs the payment function through the payment card information in the checked additional setting information. In this case, the user equipment 100 may perform the payment function in accordance with the lumpsum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment control unit 150 receives a payment function performed result in accordance with the performing of a payment function provided from the service providing device 300 (or the payment server 500) through the user equipment communication unit 110 and outputs the received payment function performed result through the user equipment display unit 130 and/or the user equipment voice output unit 140.

Further, the user equipment control unit 150 may output the payment function performed result transmitted from the payment server 500 through the shopping web site which is provided from the service providing device 300.

Further, when a payment function on one or more products is normally completed, the user equipment control unit 150 checks the additional setting information based on the position information (or position information of the user equipment 100 and/or current time information) of the user equipment 100 which is previously checked.

Further, the user equipment control unit 150 transmits the checked additional setting information and the identification information of the user equipment 100 to the service providing device 300 through the user equipment communication unit 110. In this case, the additional setting information includes a delivery address (or delivery information), payment card information, and recommendation criteria (or preference profile). Here, the identification information of the user equipment 100 includes a mobile directory number (MDN), a mobile IP, a mobile MAC, a subscriber identify module (Sim) card unique information, and a serial number.

As a determination result (or as a checking result), when the identification information of the previously tagged NFC tag is included in the unique identification information of the NFC tag which interlocks with the purchased product information, the user equipment control unit 150 displays at least one purchased product information which interlocks with the previously tagged NFC tag 600 on the user equipment display unit 130 through the executing dedicated app or the web service.

Further, the user equipment control unit 150 displays at least one purchased product information which interlocks with the identification information of the previously tagged NFC tag on the user equipment display unit 130 and also automatically adds (or stores) the related product (or related product information) in a cart item.

As a determination result (or as a checking result), when product information related with the previously tagged NFC tag is included among the unique identification information of the NFC tag and the purchased product information which are interlocked in advance, the user equipment control unit 150 displays at least one purchased product information which interlocks with the product information related with the previously tagged NFC tag on the user equipment display unit 130 through the executing dedicated app or the web service and also stores the at least one purchased product information in the cart item.

Further, when a predetermined button (for example, a purchase confirmation button) displayed on the user equipment display unit 130 is selected or a tagging function on another NFC tag 600 is not performed, the user equipment control unit 150 interlocks with the service providing device 300 and the payment server 500 to perform a payment function in accordance with lumpsum ordering function on at least one product related with at least one purchased product information which is stored in the cart item of the user equipment 100 and previously checked. In this case, the user equipment control unit 150 checks additional setting information based on the position information (or position information of the user equipment 100 and/or current time information) of the user equipment 100 which is previously checked and performs the payment function through the payment card information in the checked additional setting information. In this case, the user equipment 100 may perform the payment function in accordance with the lump sum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment control unit 150 receives a payment function performed result in accordance with the performing of a payment function provided from the service providing device 300 (or the payment server 500) through the user equipment communication unit 110 and outputs the received payment function performed result through the user equipment display unit 130 and/or the user equipment voice output unit 140. Here, the payment function performed result (or the payment information) includes at least one product name, a unique product code, a unit price, an amount, a discounted price, whether to apply a coupon, a price, a total price, payment date and time information, and a payment card type.

Further, when a payment function on at least one product is normally completed, the user equipment control unit 150 checks the additional setting information based on the position information (or position information of the user equipment 100 and/or current time information) of the user equipment 100 which is previously checked. In this case, the additional setting information includes a delivery address, payment card information, and recommendation criteria (or preference profile).

Further, the user equipment control unit 150 transmits the checked additional setting information to the service providing device 300 through the user equipment communication unit 110.

As described above, when product information of a product (or a product which is repeatedly purchased) which is frequently purchased is set to interlock with the identification information of the NFC tag 600 in advance, an app is called by simply tagging the NFC tag 600 to search a related frequently purchased product which is set to interlock with the identification information of the NFC tag. Thereafter, the deliver address is set based on the current position of the user equipment 100 and the purchase is also automatically performed, so that convenience of the user may be improved.

Further, when the payment function on one or more products (or at least one product) is normally completed in the user equipment 100, the user of the user equipment 100 receives one or more products (or at least one product related with at least one product information) related with one or more product information which is delivered through the delivery device 700. In this case, when one or more products are provided by different companies, the user of the user equipment 100 may receive the products which are individually delivered for every company through the delivery device 700.

Further, the user of the user equipment 100 receives the product which is delivered from the service providing device 300 (or a company which supplies the product/delivery device 700) based on delivery location information which is transmitted from the user equipment 100 to the service providing device 300.

Specifically, the NFC tag 600 may interlock with not only on-line shopping malls but also various delivery apps to be connected with an off-line delivery service. In this case, the position of the user equipment 100 is considered as an order position so that the order may be conveniently performed.

For example, when a user wants to order a chicken in the Hangang River, the user orders the chicken after simply tagging the NFC tag 600 so that the chicken is delivered to the Hangang River area where the user equipment 100 (or a user of the user equipment 100) is located.

Further, a plurality of orders is allowed by tagging the plurality of NFC tags 600 plural times, so that a chicken and pizza may be ordered at one time to a desired location.

In the meantime, in the case of automatic product interlocking by the tagging, in a specific shopping mall, information which allows to repeat the same transaction or purchase the same product may interlock with the tag identification information based on the information included in the order history just by selecting the order history. Further, also in the case of agency payment service purchase using price comparison, information which allows to repeat the same transaction or to purchase the same product may interlock with the tag identification information just by selecting a product which is already purchased from the order history in accordance with the agency payment purchase.

When the above-described interlocking is set, position information of the user equipment 100, payment information, and a preference profile are also reflected so that a complex setting manipulation is not required.

As described above, a combination of tags for products to be purchased and a tag for a shopping mall is input at one time to allow the lump sum purchase and a delivery status of the product which is currently being delivered may be checked through tagging.

Further, as described above, a specific online shopping mall or a tag which induces a connected status for purchasing a specific product in the shopping mall are used, but differently from the NFC tagging method which performs one independent job by one contact, a plurality of product related NFC tags is continuously tagged and then the plurality of tagged products is ordered in lump sum.

Further, as described above, in the case of a product which is ordered through the NFC tag but is not delivered, a delivery tracking screen for the order including the product may be provided just by tagging the NFC tag.

Further, as described above, a combination of tags for products to be purchased and a tag for the shopping mall is input at one time to allow the lump sum purchase. However, even though the same tag is used, different delivery addresses, payment means, and recommended profiles may be applied in accordance with the location of the user equipment.

Further, as described above, a specific online shopping mall or a tag which induces a connected status for purchasing a specific product in the shopping mall are used, but differently from the NFC tagging method which performs one independent job by one contact, a plurality of product related NFC tags is continuously tagged and then the plurality of tagged products is ordered in lump sum.

Further, additional setting information for shopping may be automatically applied in accordance with the tagging position and the tagging time of the user equipment.

Hereinafter, a control method of a payment system according to an exemplary embodiment of the present invention will be described in detail with reference to FIGS. 1 to 9.

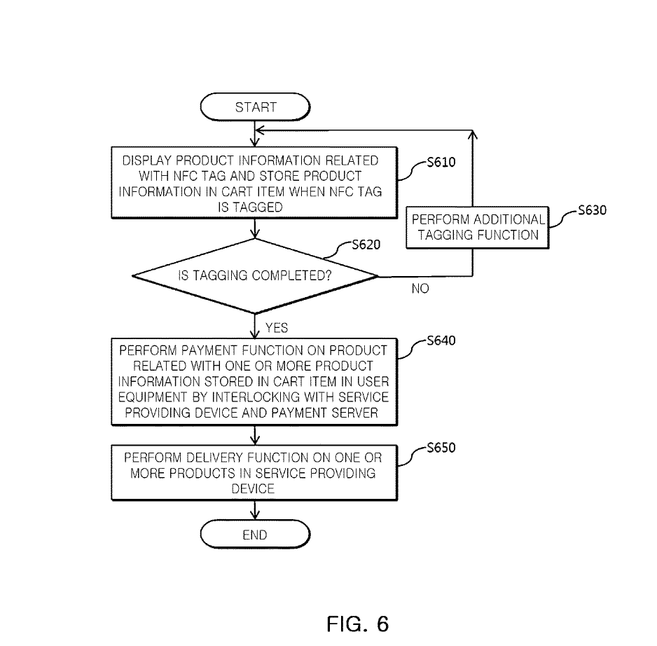

FIG. 6 is a flow chart illustrating a control method of a payment system according to a first exemplary embodiment of the present invention.

First, when an arbitrary NFC tag 600 is tagged in the user equipment 100, the user equipment 100 displays product information related with the NFC tag 600 in accordance with the tagging of the NFC tag 600 through a dedicated app which is installed in advance in the user equipment 100 or a web service. Here, the NFC tag 600 contains (or stores) product information related with one or more products and may be related with a product which is repeatedly purchased by the user of the user equipment 100.

In this case, the product information related with the NFC tag 600 may be product information of the cheapest product among searching results in a predetermined shopping mall site (for example, including “11 street”) with respect to a specific product related with the NFC tag 600.

Further, the searching results in one or more shopping mall sites (for example, including “11 street”) with respect to a specific product related with the NFC tag 600 are displayed on the user equipment 100 and the product information related with the NFC tag 600 may be product information of a product selected from the one or more searching results displayed on the user equipment 100.

Further, the user equipment 100 displays the product information related with the NFC tag 600 and also automatically adds (or stores) the related product (or related product information) in a cart item of the dedicated app or the web service.

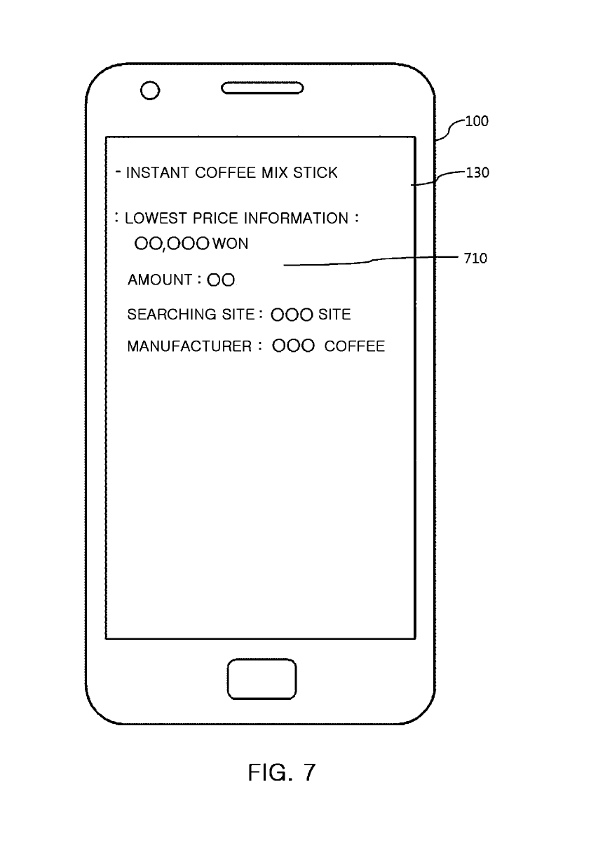

For example, when a first NFC tag 600 related with an instant coffee mix stick is tagged in first user equipment 100, as illustrated in FIG. 7, the first user equipment displays first product information 710 which is the lowest cost of the instant coffee mix stick searched from a first shopping mall site related with the first NFC tag through a shopping app which is installed in advance in the first user equipment and adds the first product information in the cart item.

As another example, when an eleventh NFC tag 600 related with one-time use green tea teabag is tagged in second user equipment 100, the second user equipment displays a plurality of product information related with the one-time use green tea teabag searched from first to fifth shopping mall sites related with the eleventh NFC tag through a shopping web site provided by the service providing device 300 and adds the eleventh product information in the cart item in accordance with the user selection (or user touch) (S610).

Next, the user equipment 100 checks (or determines) whether the tagging of the NFC tag is completed.

That is, the user equipment 100 checks whether the tagging is performed on another NFC tag 600 within a predetermined time (for example, within 10 seconds) or whether a NFC tag 600 including predetermined tag completed information is tagged.

For example, the first user equipment checks whether the NFC tag 600 is additionally tagged within a predetermined time (for example, within 10 seconds).

As another example, the second user equipment checks whether an NFC tag including a predetermined tag completion information is tagged (S620).

As a checking result (or determination result), when the tagging of the NFC tag is not completed, that is, a tagging function on another NFC tag 600 is continuously performed, the user equipment 160 repeatedly performs the previous steps (or step S610) to cumulatively store one or more product information related with the repeatedly purchased product in the cart item.

For example, when tagging functions on a second NFC tag, a third NFC tag, and a fourth NFC tag are additionally performed through the first user equipment within a predetermined time (for example, within ten seconds), the first user equipment temporarily stores first product information corresponding to the first NFC tag related with the instant coffee mix stick, second product information corresponding to the second NFC tag related with a roll tissue, third product information corresponding to the third NFC tag related with a tissue, and fourth product information corresponding to the fourth NFC tag related with a disposable paper cup, in the cart item.

As another example, when additional tagging functions on twelfth NFC tag and thirteenth NFC tag are performed through second user equipment without tagging the NFC tag including predetermined tag completion information, the second user equipment temporarily stores eleventh product information corresponding to the eleventh NFC tag related with the above one-time use green tea teabag, twelfth product information corresponding to the twelfth NFC tag related with the disposable paper cup, and thirteenth product information corresponding to the thirteenth NFC tag related with an instant hot choco stick in the card item (S630).

Further, as a checking result (or a determination result), when the tagging of the NFC tag is completed, that is, a tagging function on another NFC tag 600 is not performed, the user equipment 100 interlocks with the service providing device 300 and the payment server 500 to perform a payment function in accordance with a lump sum ordering function on one or more products related with one or more product information stored in the cart item of the user equipment 100. In this case, the user equipment 100 may perform the payment function in accordance with the lump sum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment 100 receives a payment function performed result in accordance with the performing of a payment function provided from the service providing device 300 (or the payment server 500) and displays the received payment function performed result. Here, the payment function performed result (or the payment information) includes one or more product names, a unique product code, a unit price, an amount, a discounted price, whether to apply a coupon, a price, a total price, payment date and time information, and a payment card type.

For example, when additional tagging on another NFC tag 600 is not performed within a predetermined time (for example, within 10 seconds) after tagging the first to fourth NFC tags, the first user equipment interlocks with the service providing device 300 and the payment server 500 to perform the payment function based on a previously stored card information in the first user equipment for simple payment for a first payment amount corresponding to the instant coffee mix stick, the roll tissue, the tissue, and the disposable paper cup respectively corresponding to the first product information (or product information related with the instant coffee mix stick), the second product information (or product information related with the roll tissue), the third product information (or product information related with the tissue), and the fourth product information (or product information related with the disposable paper cup). Further, when the payment function is normally completed, the first user equipment receives the first payment function performed result transmitted from the service providing device 300 and displays the received first payment function performed result.

Further, when an NFC tag including predetermined tag completion information is tagged after tagging the eleventh to thirteenth NFC tags, the second user equipment interlocks with the service providing device 300 and the payment server 500 to perform the payment function of a second payment amount corresponding to the one-time use green tea teabag, the disposable paper cup, and the instant hot choco stick respectively corresponding to the eleventh product information (or product information related with the one-time use green tea teabag), the twelfth product information (or product information relate with the disposable paper cup), and the thirteenth product information (or product information related with the instant hot choco stick). Further, when the payment function is normally completed, the second user equipment displays a second payment function performed result transmitted from the payment server 500 through a shopping web site provided by the service providing device 300 (S640).

Next, when the payment function on one or more products is normally completed in the user equipment 100, the service providing device 300 performs a delivery function on one or more products related with the one or more product information through the delivery device 700. In this case, when one or more products are provided by different companies, the service providing device 300 may perform the delivery function on the products for every company.

For example, when the payment function on the instant coffee mix stick, the roll tissue, the tissue, and the disposable paper cup is normally completed, the service providing device 300 performs a delivery function on the instant coffee mix stick, the roll tissue, the tissue, and the disposable paper cup based on the delivery information related with the first user equipment.

As another example, when the payment function on the one-time use green tea teabag, the disposable paper cup, and the instant hot choco stick is normally completed, the service providing device 300 performs a delivery function on the one-time use green tea teabag, the disposable paper cup, and the instant hot choco stick based on the delivery information related with the second user equipment (S650).

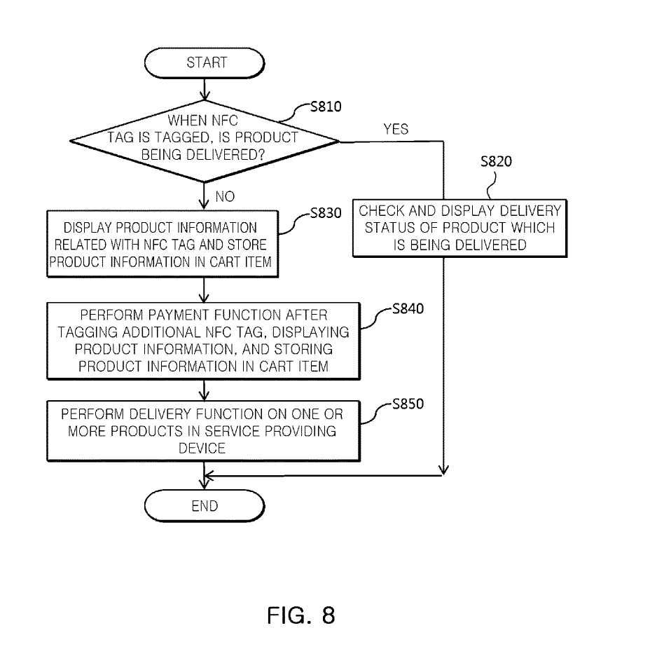

FIG. 8 is a flow chart illustrating a control method of a payment system according to a second exemplary embodiment of the present invention.

First, when an arbitrary NFC tag 600 is tagged in the user equipment 100, the user equipment 100 checks (or determines) whether a product corresponding to the identification information of the tagged NFC tag 600 is included among one or more products corresponding to the identification information of one or more NFC tags 600 which is being delivered related with the user equipment 100 through a dedicated app which is installed in advance in the user equipment 100 or the web service. Here, the NFC tag 600 may include (or store) product information related with one or more products.

That is, when an arbitrary NFC tag 600 is tagged in the user equipment 100, the user equipment 100 checks (or determines) whether a product corresponding to the identification information of the tagged NFC tag 600 is included, among one or more products corresponding to the identification information of the one or more NFC tags 600 which are ordered in the user equipment 100 (or among one or more products corresponding to the identification information of one or more NFC tags 600 which have been ordered in the user equipment 100 but have not been delivered).

For example, when the first NFC tag 600 related with the instant coffee mix stick is tagged in the third user equipment 100, the third user equipment checks whether the instant coffee mix stick related with the first NFC tag is included among the plurality of products which is previously purchased but has not been delivered in the third user equipment (S810).

As a checking result (or a determination result), when a product corresponding to the identification information of the tagged NFC tag 600 is included among one or more products corresponding to the identification information of one or more NFC tags 600 which are being delivered, related with the user equipment 100, the user equipment 100 interlocks with the service providing device 300 to check position information (or a delivering status/a delivering status in accordance with the position information) of a delivery vehicle 700 which is delivering the product corresponding to the identification information of the tagged NFC tag 600 (or a terminal (not illustrated) carried by a delivery man who takes the delivery vehicle 700 which is delivering the product) and displays the checked position information (or the delivering status) of the delivery vehicle 700.

That is, as a checking result (or a determination result), when a product corresponding to the identification information of the tagged NFC tag 600 is being delivered, the user equipment 100 interlocks with the service providing device 300 to check position information (or a delivering status/a delivering status in accordance with the position information) of a delivery vehicle 700 which is delivering the product corresponding to the identification information of the tagged NFC tag 600 (or a terminal (not illustrated) carried by a delivery man who takes the delivery vehicle 700 which is delivering the product) and displays the checked position information (or the delivering status) of the delivery vehicle 700.

Further, as a checking result (or a determination result), when a product corresponding to the identification information of the tagged NFC tag 600 is included among one or more products corresponding to the identification information of one or more NFC tags 600 which are ordered in the user equipment 100 (or one or more products corresponding to the identification information of the one or more NFC tags 600 which are ordered in the user equipment 100 but have not been delivered), the user equipment 100 interlocks with the service providing device 300 to check position information (or delivery status) of the delivery vehicle 700 (or a terminal (not illustrated) carried by a delivery man who takes the delivery vehicle 700 which is delivering the product) which is delivering the product corresponding to the identification information of the tagged NFC tag 600 and displays the checked position information (or the delivering status) of the delivery vehicle 700.

For example, when the instant coffee mix stick related with the first NFC tag which is previously tagged is included among a plurality of products which is purchased by the third user equipment but has not been delivered, the third user equipment interlocks with the service providing device 300 to check the delivery status (for example, being delivered, shipped from ABC depot at 14:31:51 on December 1) in accordance with the position information of a delivery vehicle 700 which is delivering the instant coffee mix stick and displays the checked delivery status of the instant coffee mix stick (S820).

Further, as a checking result (or a determination result), when a product corresponding to the identification information of the tagged NFC tag 600 is not included among one or more products corresponding to the identification information of one or more NFC tags 600 which are being delivered related with the user equipment 100 through the executed app or web service which is installed in advance in the user equipment 100 or when the NFC tag 600 is tagged but there is no product which is being delivered related with the user equipment 100, the user equipment 100 displays the product information related with the tagged NFC tag 600. Here, the NFC tag 600 contains (or stores) product information related with one or more products and may be related with a product which is repeatedly purchased by the user of the user equipment 100.

That is, as a checking result (or a determination result), when the product corresponding to the identification information of the tagged NFC tag 600 is not being delivered, the user equipment 100 displays the product information related with the tagged NFC tag 600.

In this case, the product information related with the NFC tag 600 may be product information of the cheapest product among searching results in a predetermined shopping mall site (for example, including “11 street”) with respect to a specific product related with the NFC tag 600.

Further, the searching results in one or more shopping mall sites (for example, including “11 street”) with respect to a specific product related with the NFC tag 600 are displayed on the user equipment 100 and the product information related with the NFC tag 600 may be product information of a product selected from the one or more searching results displayed on the user equipment 100.

Further, the user equipment 100 displays the product information related with the NFC tag 600 and also automatically adds (or stores) the related product (or related product information) in a cart item of the dedicated app or the web service.

Further, as a checking result (or a determination result), when a product corresponding to the identification information of the tagged NFC tag 600 is not included among one or more products corresponding to the identification information of the one or more NFC tags 600 which are ordered in the user equipment 100 (or among one or more products corresponding to the identification information of one or more NFC tags 600 which have been ordered in the user equipment 100 but have not been delivered) or when the NFC tag 600 is tagged but there is no product which is being delivered related with the user equipment 100, the user equipment 100 may display the product information related with the tagged NFC tag 600.

For example, when the instant coffee mix stick related with the first NFC tag which is previously tagged is not included among a plurality of products which is purchased by the third user equipment but has not been delivered, the third user equipment displays first product information which is the lowest cost information for the instant coffee mix stick searched from the first shopping mall site related with the first NFC tag through a shopping app which is installed in advance in the third user equipment and adds the first product information in the cart item (S830).

Next, the user equipment 100 tries to additionally tag one or more NFC tags 600 and automatically adds one or more product information related with the repeatedly purchased product in accordance with the additional tagging in the cart item.

Further, when the additional tagging of the NFC tag is completed, that is, a tagging function on another NFC tag 600 is not performed, the user equipment 100 interlocks with the service providing device 300 and the payment server 500 to perform a payment function in accordance with a lump sum ordering function on one or more products related with one or more product information stored in the cart item. In this case, the user equipment 100 checks additional setting information based on the position information (or position information of the user equipment 100 and/or current time information) of the user equipment 100 which is checked in real time and performs the payment function through the payment card information in the checked additional setting information. In this case, the user equipment 100 may perform the payment function in accordance with the lump sum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment 100 receives a payment function performed result in accordance with the performing of a payment function provided from the service providing device 300 (or the payment server 500) and displays the received payment function performed result. Here, the payment function performed result (or the payment information) includes one or more product names, a unique product code, a unit price, an amount, a discounted price, whether to apply a coupon, a price, a total price, payment date and time information, and a payment card type.

Further, when the payment function on one or more products is normally completed, the user equipment 100 checks additional setting information based on the checked position information (or position information and/or current time information of the user equipment 100) of the user equipment 100 and transmits the checked additional setting information and the identification information of the user equipment 100 to the service providing device 300. In this case, the additional setting information includes a delivery address (or delivery information), payment card information, and recommendation criteria (or preference profile). Here, the identification information of the user equipment 100 includes a mobile directory number (MDN), a mobile IP, a mobile MAC, a subscriber identify module (Sim) card unique information, and a serial number.

For example, in a state when an instant coffee mix stick, a disposable diaper, and a disposable wet tissue are temporarily stored in the cart item of a shopping app in accordance with the additional tagging, when additional tagging on another NFC tag 600 is not performed within a predetermined time (for example, within 10 seconds), the third user equipment interlocks with the service providing device 300 and the payment server 500 to perform a payment function of a third payment amount corresponding to 31-st product information (or product information related with the instant coffee mix stick), 32-nd product information (or product information related with the disposable diaper) and 33-rd product information (or product information related with the disposable wet tissue). In this case, the third user equipment performs the payment function through an eleventh payment card among a plurality of payment cards which is issued to the third user equipment based on the position information of the third user equipment corresponding to a company (or an office) where the third user equipment is located which is checked in real time. Further, the payment function is normally completed, the third user equipment receives the third payment function performed result transmitted from the service providing device 300 and displays the received third payment function performed result (S840).

Next, when the payment function on one or more products is normally completed in the user equipment 100, the service providing device 300 performs a delivery function on one or more products related with the one or more product information through the delivery device 700. In this case, when one or more products are provided by different companies, the service providing device 300 may perform the delivery function on the products for every company.

As another example, when the payment function on the instant coffee mix stick, the disposable diaper, and the wet tissue is normally completed, the service providing device 300 performs a delivery function on the instant coffee mix stick, the disposable diaper, and the wet tissue based on the delivery information related with the first user equipment (S850).

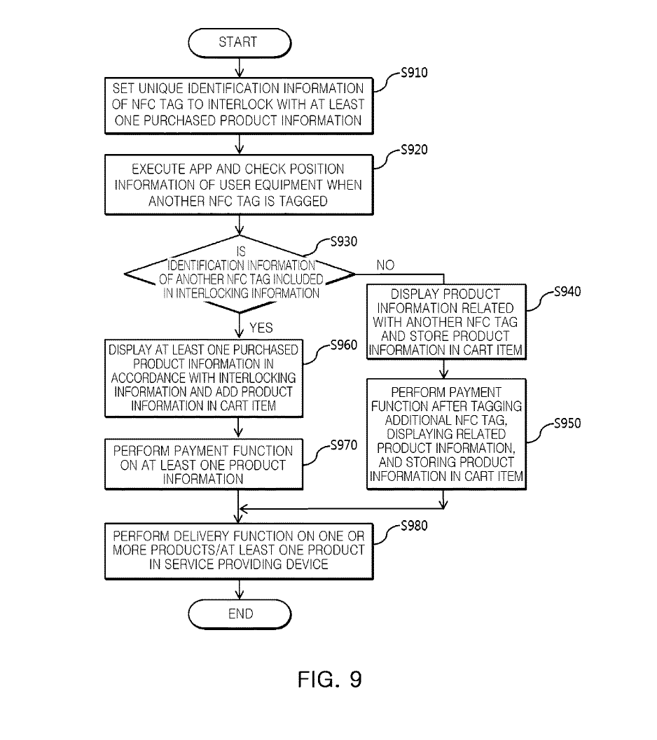

FIG. 9 is a flow chart illustrating a control method of a payment system according to a third exemplary embodiment of the present invention.

The user equipment 100 may set the unique identification information of the NFC tag tagged in the user equipment 100 and at least one product information purchased through the user equipment 100 to interlock with each other. In this case, at least one product information may include product information related with the unique identification information of the tagged NFC tag 600.

For example, the first user equipment 100 sets the unique identification information of the third NFC tag 600 related with the tissue tagged in the first user equipment to interlock with the first product information (or product information related with the instant coffee mix stick) which is purchased through the third user equipment, the second product information (or product information related with the roll tissue), the third product information (or product information related with the tissue), and the fourth product information (or product information related with the disposable paper cup) (S910).

Next, when an arbitrary NFC tag 600 is tagged in the user equipment 100, the user equipment 100 displays product information related with the NFC tag 600 in accordance with the tagging of the NFC tag 600 through a dedicated app which is installed in advance in the user equipment 100 or a web service. Here, the NFC tag 600 contains (or stores) product information related with one or more products and may be related with a product which is repeatedly purchased by the user of the user equipment 100.

For example, when the third NFC tag related with the tissue is tagged in the first user equipment, the first user equipment executes a shopping app which is installed in advance in the first user equipment and checks the position information (or the first position information) of the first user equipment corresponding to a house (or home) where the first user equipment is located.

As another example, when the 31-st NFC tag related with a one-time use black tea teabag is tagged in the first user equipment, the first user equipment accesses a shopping web site which is provided by the service providing device 300 and checks the position information (or second position information) of the first user equipment corresponding to the company (or office) where the first user equipment is located (S920).

Next, the user equipment 100 determines (or checks) whether the identification information of the tagged arbitrary NFC tag is included in the unique identification information of the NFC tag which interlocks with the purchased product information (or at least one purchased product information).

Further, the user equipment 100 may determine whether the product information related with the previously tagged arbitrary NFC tag is included among the unique identification information of the NFC tag and the purchased product information which are interlocked in advance.

For example, it is determined whether identification information of the third NFC tag related with the tissue tagged in the previous step (or in step S920) is included in the unique identification information of the third NFC tag related with the tissue which interlocks with first to fourth product information (or product information related with the instant coffee mix stick, the roll tissue, the tissue, and the disposable paper cup).

As another example, it is determined whether identification information of the 31-st NFC tag related with the one-time use black tea teabag tagged in the previous step is included in the unique identification information of the third NFC tag related with the tissue which interlocks with first to fourth product information (or product information related with the instant coffee mix stick, the roll tissue, the tissue, and the disposable paper cup).

As another example, it is determined whether product information related with the roll tissue of the tagged second NFC tag is included in the unique identification information of the third NFC tag related with the tissue which interlocks with first to fourth product information (or product information related with the instant coffee mix stick, the roll tissue, the tissue, and the disposable paper cup) (S930).

As a determination result (or as a checking result), when the identification information of the previously tagged NFC tag is not included in the unique identification information of the NFC tag which interlocks with the purchased product information, the user equipment 100 displays the product information related with the previously tagged NFC tag 600 through the executing dedicated app or the web service. Here, the NFC tag 600 may include product information related with one or more products.

In this case, the product information related with the NFC tag 600 may be product information of the cheapest product among searching results in a predetermined shopping mall site (for example, including “11 street”) with respect to a specific product related with the NFC tag 600.

Further, the searching results in one or more shopping mall sites (for example, including “11 street”) with respect to a specific product related with the NFC tag 600 are displayed on the user equipment 100 and the product information related with the NFC tag 600 may be product information of a product selected from the one or more searching results displayed on the user equipment 100.

Further, the user equipment 100 displays the product information related with the NFC tag 600 and also automatically adds (or stores) the related product (or related product information) in a cart item of the dedicated app or the web service.

As a determination result (or as a checking result), when product information related with the previously tagged NFC tag is not included among the unique identification information of the NFC tag and the purchased product information which are interlocked in advance, the user equipment 100 displays the product information related with the previously tagged NFC tag 600 on the user equipment display unit 130 through the executing dedicated app or the web service and also stores the product information in the cart item.

For example, when the identification information of the 31-st NFC tag related with the one-time use black tea teabag which is previously tagged is not included in the unique identification information of the third NFC tag related with the tissue which interlocks with the plurality of first to fourth product information (or product information related with the instant coffee mix stick, the roll tissue, the tissue, and the disposable paper cup), the user equipment 100 displays the 31-st product information which is the lowest cost information for the one-time use black tea teabag searched from the first shopping site related with the 31-st NFC tag for the one-time use black tea teabag through the shopping app and adds the 31-st product information in the cart item (S940).

Next, the user equipment 100 tries to additionally tag one or more NFC tags 600 and automatically adds one or more product information related with the repeatedly purchased product in accordance with the additional tagging in the cart item.

Further, when the additional tagging of the NFC tag is completed, that is, a tagging function on another NFC tag 600 is not performed, the user equipment 100 interlocks with the service providing device 300 and the payment server 500 to perform a payment function in accordance with a lump sum ordering function on one or more products related with one or more product information stored in the cart item of the user equipment 100. In this case, the user equipment 100 checks additional setting information based on the position information (or position information of the user equipment 100 and/or current time information) of the user equipment 100 which is previously checked and performs the payment function through the payment card information in the checked additional setting information. In this case, the user equipment 100 may perform the payment function in accordance with the lump sum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment 100 receives a payment function performed result in accordance with the performing of a payment function provided from the service providing device 300 (or the payment server 500) and displays the received payment function performed result. Here, the payment function performed result (or the payment information) includes one or more product names, a unique product code, a unit price, an amount, a discounted price, whether to apply a coupon, a price, a total price, payment date and time information, and a payment card type.

Further, when the payment function on one or more products is normally completed, the user equipment 100 checks additional setting information based on the previously checked position information (or position information and/or current time information of the user equipment 100) of the user equipment 100 and transmits the checked additional setting information and the identification information of the user equipment 100 to the service providing device 300. In this case, the additional setting information includes a delivery address (or delivery information), payment card information, and recommendation criteria (or preference profile). Here, the identification information of the user equipment 100 includes a mobile directory number (MDN), a mobile IP, a mobile MAC, a subscriber identify module (Sim) card unique information, and a serial number.

For example, in a state when one-time use black tea teabag, a tooth paste, and a tooth brush are temporarily stored in the cart item of a shopping app in accordance with the additional tagging, when additional tagging on another NFC tag 600 is not performed within a predetermined time (for example, within 10 seconds), the first user equipment interlocks with the service providing device 300 and the payment server 500 to perform a payment function of a third payment amount corresponding to 31-st product information (or product information related with the one-time use black tea teabag), 32-nd product information (or product information related with the tooth paste) and 33-rd product information (or product information related with the tooth brush). In this case, the first user equipment performs the payment function through an eleventh payment card among a plurality of payment cards which is issued to the first user equipment based on the position information (or the second position information) of the first user equipment corresponding to a company (or an office) where the first user equipment is located which is previously checked. Further, the payment function is normally completed, the first user equipment receives the third payment function performed result transmitted from the service providing device 300 and displays the received third payment function performed result.

Further, the first user equipment transmits the eleventh delivery address in which the company is the delivery location based on the position information (or the second position information) of the first user equipment corresponding to the company (or the office) where the first user equipment is located which is previously checked and the identification information of the first user equipment to the service providing device 300 (S950).

As a determination result (or as a checking result), when the identification information of the previously tagged NFC tag is included in the unique identification information of the NFC tag which interlocks with the purchased product information, the user equipment 100 displays at least one purchased product information which interlocks with the identification information of the previously tagged NFC tag 600 through an executed dedicated app or an executing web service on the user equipment display unit 130.

Further, the user equipment 100 displays at least one purchased product information which interlocks with the identification information of the previously tagged NFC tag and also automatically adds (or stores) the related product (or related product information) in a cart item.

As a determination result (or as a checking result), when product information related with the previously tagged NFC tag is included among the unique identification information of the NFC tag and the purchased product information which are interlocked in advance, the user equipment 100 displays at least one purchased product information which interlocks with the product information related with the previously tagged NFC tag through the executing dedicated app or the web service and also stores the at least one purchased product information in the cart item.

For example, when the identification information of the third NFC tag related with the tissue which is previously tagged is included in the unique identification information of the third NFC tag related with the tissue which interlocks with the plurality of first to fourth product information (or product information related with the instant coffee mix stick, the roll tissue, the tissue, and the disposable paper cup), the first user equipment displays the plurality of first to fourth product information (or product information related with the instant coffee mix stick, the roll tissue, the tissue, and the disposable paper cup) which interlocks with the identification information of the third NFC tag related with the tissue which is previously tagged through a shopping app and temporarily stores the plurality of first to fourth product information in the cart item in the shopping app.

As another example, when product information related with the roll tissue of the tagged second NFC tag is included in the unique identification information of the third NFC tag related with the tissue which interlocks with the plurality of first to fourth product information (or product information related with the instant coffee mix stick, the roll tissue, the tissue, and the disposable paper cup), the first user equipment displays the plurality of first to fourth product information (or product information related with the instant coffee mix stick, the roll tissue, the tissue, and the disposable paper cup) which interlocks with the product information related with the roll tissue through a shopping app and temporarily stores the plurality of first to fourth product information in the cart item in the shopping app (S960).

Further, when a predetermined button (for example, a purchase confirmation button) on the dedicated app or the web service is selected or a tagging function on another NFC tag 600 is not performed, the user equipment 100 interlocks with the service providing device 300 and the payment server 500 to perform a payment function in accordance with a lump sum ordering function on at least one product related with at least one purchased product information which is stored in the cart item of the user equipment 100 and previously checked. In this case, the user equipment 100 checks additional setting information based on the position information (or position information of the user equipment 100 and/or current time information) of the user equipment 100 which is previously checked) and performs the payment function through the payment card information in the checked additional setting information. In this case, the user equipment 100 may perform the payment function in accordance with the lump sum ordering function on one or more products related with one or more product information stored in the cart item through card information and/or a PIN number which is stored in advance for simple payment. Here, the card information includes a card number, an expiration date, a card verification code (CVC) number, and a user name. Further, the PIN number may be a PIN number corresponding to the card information (or the payment card type).

The user equipment 100 receives a payment function performed result in accordance with the performing of a payment function provided from the service providing device 300 (or the payment server 500) and displays the received payment function performed result. Here, the payment function performed result (or the payment information) includes at least one product name, a unique product code, a unit price, an amount, a discounted price, whether to apply a coupon, a price, a total price, payment date and time information, and a payment card type.

Further, when the payment function on at least one product is normally completed, the user equipment 100 checks additional setting information based on the previously checked position information (or position information and/or current time information of the user equipment 100) of the user equipment 100 and transmits the checked additional setting information to the service providing device 300. In this case, the additional setting information includes a delivery address, payment card information, and recommendation criteria (or preference profile).

For example, in a state when the plurality of first to fourth product information (or product information related with the instant coffee mix stick, the roll tissue, the tissue, and the disposable paper cup) is temporarily stored in the cart item of the shopping app, when additional tagging on another NFC tag 600 is not performed within a predetermined time (for example, 10 seconds), the first user equipment interlocks with the service providing device 300 and the payment server 500 to perform the payment function of a fourth payment amount corresponding to the plurality of first to fourth product information (or product information related with the instant coffee mix stick, the roll tissue, the tissue, and the disposable paper cup). In this case, the first user equipment performs the payment function through a twelfth payment card among a plurality of payment cards which is issued to the first user equipment based on the position information (or the first position information) of the first user equipment corresponding to the house where the first user equipment is located which is previously checked. Further, the payment function is normally completed, the first user equipment receives the fourth payment function performed result transmitted from the service providing device 300 and displays the received fourth payment function performed result.

Further, the first user equipment transmits the twelfth delivery address in which the house (or home) is the delivery location based on the position information (or the first position information) of the first user equipment corresponding to the house (or the home) where the first user equipment is located which is previously checked and the identification information of the first user equipment to the service providing device 300 (S970).

Next, when the payment function on one or more products (or at least one product) is normally completed in the user equipment 100, the service providing device 300 performs a delivery function on one or more products (or at least one product related with at least one product information) related with one or more product information which is delivered through the delivery device 700. In this case, when one or more products (or at least one product) are provided by different companies, the service providing device 300 may perform the delivery function on the products for every company. Here, the service providing device 300 may perform the delivery function based on the delivery address in accordance with the position information of the user equipment 100 provided from the user equipment 100.

For example, when the payment function on the plurality of first to fourth product information (or product information related with the instant coffee mix stick, the roll tissue, the tissue, and the disposable paper cup) is normally completed, the service providing device 300 performs the delivery function on the instant coffee mix stick, the roll tissue, the tissue, and the disposable paper cup through the delivery device 700 based on the eleventh delivery address in which the house (or home) is the delivery location transmitted from the first user equipment.

As another example, when the payment function on the one-time use black tea teabag, the tooth paste, and the tooth brush is normally completed, the service providing device 300 performs the delivery function on the one-time use black tea teabag, the tooth paste, and the tooth brush through the delivery device 700 based on the twelfth delivery address in which the company is the delivery location transmitted from the first user equipment (S980).

The user equipment, the service providing device, the POS terminal, and the payment system including the same according to the embodiment of the present invention may be prepared with a computer program, and codes and code segments configuring the computer program may easily deduced by a computer programmer in the art. Further, the corresponding computer program is stored in a non-transitory computer readable storage medium, and read and executed by the computer or the user equipment, the beacon, the service providing device, the POS terminal, and the payment server according to the exemplary embodiment of the present invention to implement the user equipment, the service providing device, the POS terminal, and the payment system including the same.

The non-transitory computer readable storage medium includes a magnetic storage medium, an optical storage medium, and a carrier wave medium. The computer program implementing the user equipment, the service providing device, the POS terminal, and the payment system including the same according to the embodiment of the present invention may be stored and installed in embedded memories of the user equipment, the beacon, the service providing device, the POS terminal, and the payment server. Alternatively, external memories such as a smart card storing and installing the computer program implementing the user equipment, the service providing device, the POS terminal, and the payment system including the same according to the embodiment of the present invention may be installed on the user equipment, the beacon, the service providing device, the POS terminal, and the payment server through an interface.

As described above, according to the exemplary embodiment of the present invention, a combination of tags for products to be purchased and a tag for a shopping mall is input at one time to allow the lump sum purchase and a delivery status of the product which is currently being delivered may be checked through tagging, thereby improving the convenience of the user.

Further, as described above, according to the exemplary embodiment of the present invention, a specific online shopping mall or a tag which induces a connected status for purchasing a specific product in the shopping mall are used, but differently from the NFC tagging method which performs one independent job by one contact, a plurality of product related NFC tags is continuously tagged and then the plurality of tagged products is ordered in lumpsum, thereby improving the purchase convenience of the user and the convenience of the user.

Further, as described above, according to the exemplary embodiment of the present invention, in the case of a product which is ordered through the NFC tag but is not delivered, a delivery tracking screen for the order including the product may be provided just by tagging the NFC tag, thereby improving the convenience of checking the order.

Further, as described above, according to the exemplary embodiment of the present invention, a combination of tags for products to be purchased and a tag for a shopping mall is received at one time to allow lump sum purchase and different delivery address, payment means, and recommendation profiles are applied in accordance with the position of the user equipment even though the same tag is used so that the configuration is simple and maintenance cost for the tag is not necessary. Therefore, it is easy to distribute the tag so that it is easy to apply the present invention to a marketing which induces the repeated purchase of the specific shopping mall or a specific product.

Further, as described above, according to the exemplary embodiment of the present invention, a specific online shopping mall or a tag which induces a connected status for purchasing a specific product in the shopping mall are used, but differently from the NFC tagging method which performs one independent job by one contact, a plurality of product related NFC tags is continuously tagged and then the plurality of tagged products is ordered in lump sum, thereby improving the purchase convenience of the user and the convenience of the user.

Further, as described above, according to the exemplary embodiment of the present invention, additional setting information for shopping is automatically applied in accordance with the tagging position and the tagging time of the user equipment, so that manipulation for purchasing is simple.

Hereinabove, although the present invention is described by specific matters such as concrete components, and the like, embodiments, and drawings, they are provided only for assisting in the entire understanding of the present invention. Therefore, the present invention is not limited to the embodiments. Various modifications and changes may be made by those skilled in the art to which the present invention pertains from this description. Therefore, the spirit of the present invention should not be limited to the above-described embodiments, and the following claims as well as all modified equally or equivalently to the claims are intended to fall within the scope and spirit of the invention.

According to the present invention, a combination of tags for products to be purchased and a tag for a shopping mall is received at one time to allow lumpsum purchase and the delivery status of a product which is being delivered is checked by tagging, so that the purchasing convenience of the user is improved and the convenience of the user is also improved. Therefore, the present invention may be used in various fields such as a simple payment field, a NFC tag field, or a position based shopping field.

What is claimed is:

1. A user equipment, comprising:
a user equipment reader unit which tags a first NFC tag;
a user equipment storing unit which stores a product corresponding to identification information of an NFC tag which is previously purchased in the user equipment and is being delivered;
a user equipment control unit which checks whether a first product corresponding to identification information of the tagged first NFC tag is included in the product corresponding to the identification information of the NFC tag which is stored in the user equipment storing unit and is being delivered and checks position information of a delivery vehicle which is delivering the first product when the first product is included in the product corresponding to the identification information of the NFC tag which is being delivered as a checking result; and
a user equipment display unit which displays the checked position information of the delivery vehicle which is delivering the first product.

2. The user equipment of claim 1, wherein when the first product is not included in the product corresponding to the identification information of the NFC tag which is being delivered as a checking result, the user equipment control unit displays product information of the first product related with the first NFC tag which is repeatedly purchased on the user equipment display unit and automatically adds the product information in a cart item.

3. The user equipment of claim 1, wherein when there is no product which is being delivered related with the user equipment, the user equipment control unit displays product information related with the first NFC tag on the user equipment display unit and automatically adds the product information in a cart item.

4. The user equipment of claim 2, wherein the product information related with the first NFC tag which is displayed on the user equipment display unit is product information of the cheapest product among search results in a shopping mall site set for the first product related with the first NFC tag which is repeatedly purchased.

5. The user equipment of claim 2, wherein a search result from the shopping mall site set for the first product related with the NFC tag is displayed on the user equipment display unit and the product information related with the first NFC tag which is displayed on the user equipment display unit is product information of a product selected from the search result displayed on the user equipment display unit.

6. The user equipment of claim 2, wherein the user equipment control unit checks whether the tagging of the NFC tag is completed and performs a payment function in accordance with a lump sum ordering function on a product related with the product information stored in the cart item when a tagging function is not performed on another NFC tag as a checking result.

7. The user equipment of claim 6, wherein when the payment function on the product is normally completed, the user equipment control unit provides additional setting information including a delivery address based on position information of the user equipment to a service providing device.

8. The user equipment of claim 6, wherein the user equipment control unit performs a payment function in accordance with a lump sum ordering function on the product related with the product information stored in the cart item based on card information stored for simple payment.

9. A user equipment, comprising:
a user equipment storing unit which sets unique identification information of a first NFC tag which is tagged in the user equipment to interlock with product information of a product purchased by the user equipment;
a user equipment reader unit which tags a second NFC tag;
a user equipment GPS receiver which checks position information of the user equipment when the second NFC tag is tagged;
a user equipment display unit which displays the product information; and
a user equipment control unit which determines whether identification information of the tagged second NFC tag is included among unique identification information of the first NFC tag which interlocks with the product information of the purchased product stored in the user equipment storing unit, controls the user equipment display unit to display the product information of the purchased product interlocking with the identification information of the tagged second NFC tag when the identification information of the tagged second NFC tag is included among the unique identification information of the first NFC tag interlocking with the product information of the purchased product stored in the user equipment storing unit as a determination result, and adds the product information of the purchased product in the cart item.

10. The user equipment of claim 9, wherein when the identification information of the tagged second NFC tag is not included among the unique identification information of the first NFC tag interlocking with the product information of the purchased product stored in the user equipment storing unit as a determination result, the user equipment control unit controls the user equipment display unit to display the product information related with the tagged second NFC tag.

11. The user equipment of claim 9, wherein when a purchase confirmation button is selected, the user equipment control unit performs a payment function in accordance with a lump sum ordering function on the product related with the product information stored in the cart item based on card information stored for simple payment.

12. The user equipment of claim 11, wherein the user equipment control unit checks additional setting information based on the checked position information of the user equipment and performs the payment function through payment card information in the checked additional setting information.

13. The user equipment of claim 11, wherein when the payment function on the product is normally completed, the user equipment control unit checks additional setting information including at least one of a delivery address, payment card information, and recommendation criteria based on the checked position information of the user equipment and provides the checked additional setting information to a service providing device.

14. A control method of user equipment, comprising:
tagging a first NFC tag by means of user equipment reader unit;
checking whether a first product corresponding to identification information of the tagged first NFC tag is included in a product corresponding to identification information of an NFC tag which is stored in a user equipment storing unit and is being delivered, by means of a user equipment control unit;
checking position information of a delivery vehicle which is delivering the first product by means of the user equipment control unit when the first product is included in the product corresponding to the identification information of the NFC tag which is being delivered as the checking result; and
displaying the checked position information of the delivery vehicle which is delivering the first product by means of a user equipment display unit.

15. The control method of user equipment of claim 14, further comprising:
displaying product information related with the first NFC tag on the user equipment display unit and automatically adding the product information in a cart item by means of the user equipment control unit when the first product is not included in the product corresponding to the identification information of the NFC tag which is being delivered as a checking result;
checking whether the tagging of the NFC tag is completed by means of the user equipment control unit; and
performing a payment function in accordance with a lump sum ordering function on a product related with the product information stored in the cart item based on card information stored for simple payment by means of the user equipment control unit when the tagging function on another NFC tag is not performed as a checking result.

16. A non-transitory computer-readable storage medium storing a computer program recorded thereon configured to perform the method of claim 14.

17. A non-transitory computer-readable storage medium storing a computer program recorded thereon configured to perform the method of claim 15.
